(19) United States
(12) Patent Application Publication
(10) Pub. No.: US 2013/0268781 A1
(43) Pub. Date: Oct. 10, 2013

(54) STATE CONTROL DEVICE, INFORMATION PROCESSING DEVICE, COMPUTER PROGRAM PRODUCT, AND SEMICONDUCTOR DEVICE

(71) Applicant: KABUSHIKI KAISHA TOSHIBA, Tokyo (JP)

(72) Inventors: Tatsunori Kanai, Kanagawa (JP); Tetsuro Kimura, Tokyo (JP); Koichi Fujisaki, Kanagawa (JP); Junichi Segawa, Kanagawa (JP); Akihiro Shibata, Tokyo (JP); Masaya Tarui, Kanagawa (JP); Satoshi Shirai, Kanagawa (JP); Yusuke Shirota, Kanagawa (JP); Hiroyoshi Haruki, Kanagawa (JP); Haruhiko Toyama, Kanagawa (JP)

(73) Assignee: KABUSHIKI KAISHA TOSHIBA, Tokyo (JP)

(21) Appl. No.: 13/799,302

(22) Filed: Mar. 13, 2013

(30) Foreign Application Priority Data
Mar. 14, 2012 (JP) 2012-056792
Mar. 4, 2013 (JP) 2013-042039

(51) Int. Cl. G06F 1/26

(52) U.S. Cl. CPC G06F 1/26
USPC 713/300

(57) ABSTRACT

According to an embodiment, a state control device controls a state transition of an information processing device. The information processing device includes a processor; a power supply unit; and an electric storage unit. The state control device includes a controller to, when the power amount accumulated in the electric storage unit is decreased to a first power amount while the information processing device is in a first state, cause the information processing device to transit from the first state to a second state in which power consumption of the processor is lower than that in the first state, and to, when the power amount accumulated in the electric storage unit is increased to a second power amount larger than the first power amount while the information processing device is in the second state, cause the information processing device to transit from the second state to the first state.

### CROSS-REFERENCE TO RELATED APPLICATIONS

This application is based upon and claims the benefit of priority from Japanese Patent Application No. 2012-056792, filed on Mar. 14, 2012 and Japanese Patent Application No. 2013-042039, filed on Mar. 4, 2013; the entire contents of which are incorporated herein by reference.

### FIELD

Embodiments described herein relate generally to a state control device, an information processing device, a computer program product, and a semiconductor device.

### BACKGROUND

It is desirable that portable information processing devices, such as tablet terminals, or small-sized information processing devices, such as sensor nodes, be operated using limited power efficiently. As a method for this purpose, there is known a method of reducing power consumption by stopping supply of power to unused parts. Also, there is a method in which an information processing device having an electric storage unit, such as a capacitor or a battery, enters a suspended state when a power amount accumulated in the electric storage unit is reduced, and stops operating while maintaining an operating state of a processor or an input/output device. When the capacitor or the battery is charged by an external power supply or the like and then a user instructs an execution resumption by pressing a power switch or the like, the suspended information processing device recovers the operating state of the processor or the input/output device into the state immediately before the suspend, and resumes the operation. It is preferable that such a state transition of the information processing device be transparently performed without the user's awareness.

### BRIEF DESCRIPTION OF THE DRAWINGS

FIG. 1 is an appearance diagram of an information processing device according to an embodiment;

FIG. 2 is a block diagram illustrating a configuration example of the information processing device according to the embodiment;

FIG. 3 is a diagram describing a state transition of the information processing device according to the embodiment;

FIG. 4 is a diagram describing a relation between a power amount accumulated in an electric storage unit and a state transition of the information processing device;

FIG. 5 is a flowchart illustrating processes performed by a state control device;

FIG. 6 is a flowchart illustrating an operation of a processor when a suspend instruction is received;

FIG. 7 is a flowchart illustrating an operation of the processor after reset processing;

FIG. 8 is a diagram describing a relation between a power amount accumulated in the electric storage unit and a state transition of the information processing device; and

FIG. 9 is a flowchart illustrating processes performed by the state control device;

FIG. 10 is a flowchart illustrating processes performed by the state control device;

FIG. 11 is a flowchart illustrating processes performed by the state control device;

FIG. 12 is a block diagram illustrating a hardware configuration example of an information processing device according to a first modification example;

FIG. 13 is a flowchart illustrating processes performed by a semiconductor device according to the first modification example;

FIG. 14 is a block diagram illustrating a hardware configuration example of an information processing device according to a second modification example;

FIG. 15 is a flowchart illustrating processes performed by a semiconductor device according to the second modification example;

FIG. 16 is a block diagram illustrating a hardware configuration example of an information processing device according to a third modification example;

FIG. 17 is a flowchart illustrating processes performed by a semiconductor device according to the third modification example;

FIG. 18 is a block diagram illustrating a hardware configuration example of an information processing device according to a fourth modification example

FIG. 19 is a flowchart illustrating processes performed by a semiconductor device according to the fourth modification example;

FIG. 20 is a block diagram illustrating a hardware configuration example of an information processing device according to a fifth modification example; and

FIG. 21 is a flowchart illustrating processes performed by a semiconductor device according to the fifth modification example.

### DETAILED DESCRIPTION

According to an embodiment, a state control device controls a state transition of an information processing device. The information processing device includes a processor; a power supply unit configured to supply power to at least the processor; and an electric storage unit configured to accumulate surplus power of the power supply unit, and supply the accumulated power to at least the processor when power supplied by the power supply unit is insufficient. The state control device includes a controller configured to, when the power amount accumulated in the electric storage unit is decreased to a first power amount while the information processing device is in a first state, cause the information processing device to transit from the first state to a second state in which power consumption of the processor is lower than that in the first state, and configured to, when the power amount accumulated in the electric storage unit is increased to a second power amount larger than the first power amount while the information processing device is in the second state, cause the information processing device to transit from the second state to the first state.

### First Embodiment

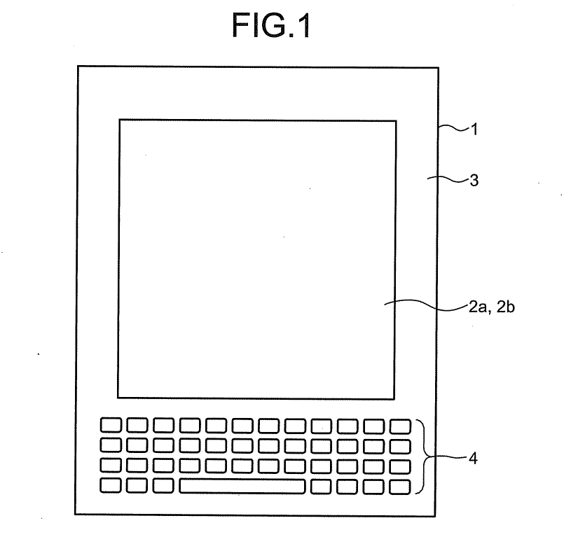

FIG. 1 is a diagram illustrating an outer appearance of an information processing device 1 according to a first embodiment. The information processing device 1 is configured as a tablet terminal driven by a solar cell. The information processing device 1 includes a display unit 2a on a terminal surface. Examples of the display unit 2a include a low-power-consumption reflective liquid crystal display, an electronic paper, and the like. Also, the information processing device 1 includes a solar cell 3 in a region other than the display unit 2a of the terminal surface. Also, the information processing device 1 includes a touch panel 2b on the surface of the display unit 2a. Furthermore, the information processing device 1 includes a keyboard 4 at a position that does not overlap the display unit 2a of the terminal surface. The keyboard 4 may be implemented by overlapping a transparent touch panel 2b on the surface of the solar cell 3. Also, the keyboard 4 may be implemented by a mechanical keyboard using a transparent material or a material in which a portion having light blocking effect is small.

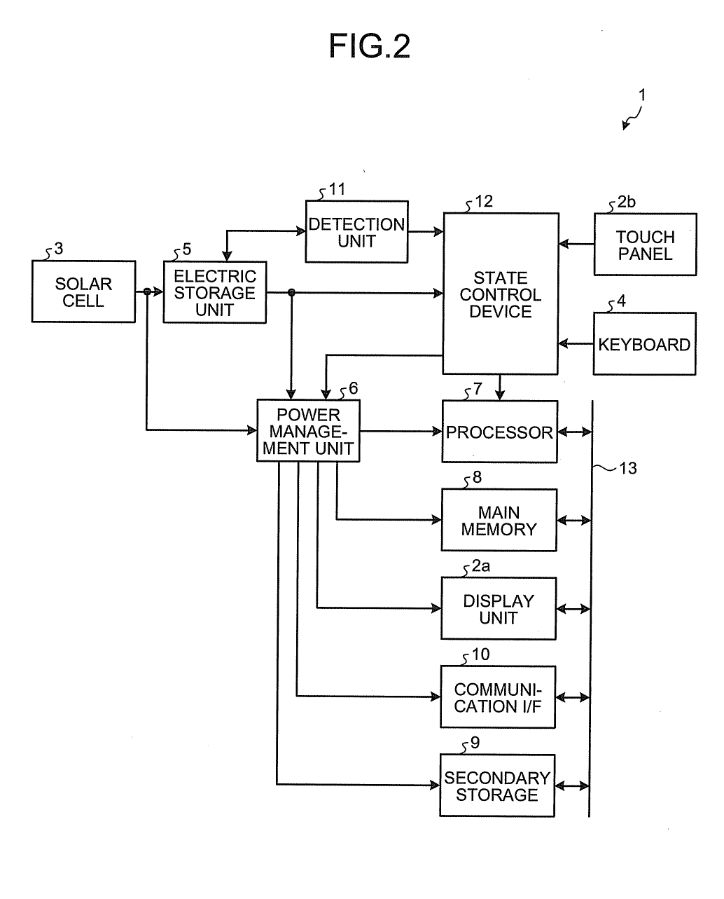

FIG. 2 is a block diagram illustrating a hardware configuration example of the information processing device 1 according to the first embodiment. The information processing device 1 includes, as a main hardware configuration, the solar cell 3 serving as a power supply unit, an electric storage unit 5 configured to accumulate surplus power, a power management unit 6 configured to manage power supply to the entire information processing device 1, a processor 7, a main memory 8, a secondary storage 9, the display unit 2a, the touch panel 2b, the keyboard 4, a communication interface (communication I/F) 10, a detection unit 11 configured to detect a power amount accumulated in the electric storage unit 5, and a state control device 12 configured to control a state transition of the information processing device 1. The processor 7, the main memory 8, the display unit 2a, the communication I/F 10, and the secondary storage 9 are connected to a bus 13.

The information processing device 1 operates with power generated by the solar cell 3. However, the power alone that is generated by the solar cell 3 may not cover peak power consumption of the entire information processing device 1 that is in an active state. For this reason, surplus power generated by the solar cell 3 during a wait state or a suspended state is accumulated in the electric storage unit 5. In the active state, the power accumulated in the electric storage unit 5 and the power generated by the solar cell 3 are added and adjusted to have a voltage necessary in the power management unit 6, and supplied to the respective parts of the information processing device 1. This power control is referred to as a peak assist or a peak shift.

In the electric storage unit 5, a high-capacity capacitor such as an electric-double-layer capacitor, a lithium-ion capacitor, or the like, or a battery such as a lithium-ion battery or the like, may be used solely or in combination. As an example of the combination, the power generated by the solar cell 3 is accumulated in the electric-double-layer capacitor, and the accumulated power is further charged in the lithium-ion battery.

The processor 7 controls the entire information processing device 1 by executing an application program or an operating system. The information processing device 1 according to the first embodiment is equipped with an operating system, for example, Linux (registered trademark) or the like.

The main memory 8 is a main storage unit that is used as a work area by the processor 7. In the main memory 8, for example, a nonvolatile memory, such as Magnetoresistive Random Access Memory (MRAM), which is readable and writable at a high speed, may be used. In addition to the MRAM, nonvolatile memories, such as Phase Change Memory (PCM) (which is also called PRAM or PCRAM) or Resistance Random Access Memory (ReRAM), may be used as the main memory 8. Also, volatile memories backed up by the electric storage unit 5, for example, Static Random Access Memory (SRAM) or Dynamic Random Access Memory (DRAM), may be used as the main memory 8.

The secondary storage 9 is an auxiliary storage unit using a nonvolatile memory, which stores data or programs required by the information processing device 1. In the secondary storage 9, for example, a flash memory may be used. Also, an SD card or an SSD may be used as the secondary storage 9.

The information processing device 1 includes the display unit 2a, the touch panel 2b, the keyboard 4, and the communication I/F 10, as the input/output device. The communication I/F 10 is an interface for performing communication by, for example, a wireless Local Area Network (LAN) or the like. In the configuration example of FIG. 2, the keyboard 4 and the touch panel 2b are connected to the state control device 12, and input data from the keyboard 4 or the touch panel 2b is received by the state control device 12 and is transferred to the processor 7. The keyboard 4 and the touch panel 2b may be connected to the processor 7 directly or through the bus 13, and input data may be received without passing through the state control device 12. The secondary storage 9 may be considered as one of the input/output devices in the relation between the processor 7 and the main memory 8. Hereinafter, when referred to as the input/output device of the information processing device 1, the secondary storage 9 is included in addition to the display unit 2a, the touch panel 2b, the keyboard 4, and the communication I/F 10.

The detection unit 11 configured to detect a power amount accumulated in the electric storage unit 5 may be implemented in various manners. For example, when a capacitor, such as an electric-double-layer capacitor, a lithium-ion capacitor, or the like, is used as the electric storage unit 5, an accumulated power amount may be known by measuring an output voltage of the capacitor. Therefore, an AD converter may be used as the detection unit 11. Also, when the state control device 12 is implemented by a low-power-consumption microcomputer embedded with an AD converter, the output voltage of the electric storage unit 5 (capacitor) is read through the AD converter, and a power amount accumulated in the electric storage unit 5 (capacitor) may be calculated from the value. That is, the state control device 12 may be configured to have the function of the detection unit 11. Also, when a battery, such as a lithium-ion battery or the like, is used as the electric storage unit 5, an accumulated power amount may be known by measuring a charging/discharging amount through a coulomb counter. Therefore, the coulomb counter may be used as the detection unit 11.

The state control device 12 monitors a power amount accumulated in the electric storage unit 5 through the detection unit 11, and controls a state transition of the information processing device 1 between an activated state (first state) and a suspended state (second state) according to the power amount accumulated in the electric storage unit 5. The state control device 12, for example, may be implemented as firmware by using a low-power-consumption microcomputer, and also may be implemented as dedicated hardware. Furthermore, partial or all functions of the state control device 12 may be implemented as software executed by the processor 7 within the information processing device 1.

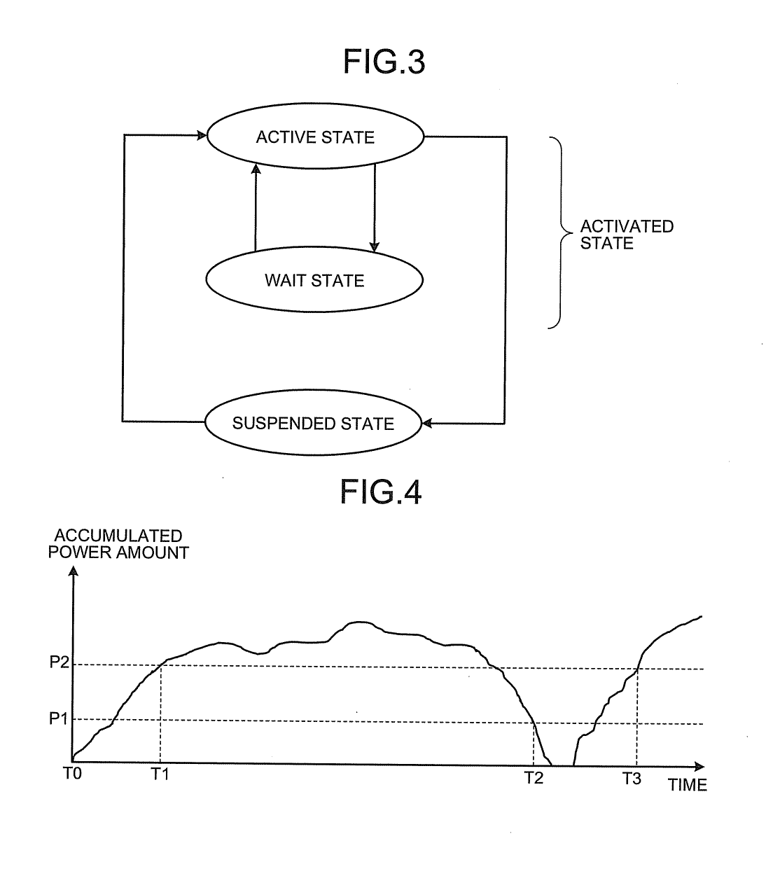

FIG. 3 is a diagram illustrating an example of a state transition of the information processing device 1. Generally, the information processing device 1 is repeatedly placed in an active state, in which the processor 7 executes processing, and a wait state in which the processor 7 waits for an interrupt from the input/output device, such as waiting for a user's input or waiting for completion of reading data from the secondary storage 9. An activated state of the information processing device 1 means a state in which the information processing device 1 is repeatedly placed in the active state and the wait state. In general, the power consumption of the information processing device 1 in the wait state is lower than that in the active state. A plurality of states corresponding to the wait state may be provided according to the configuration of the processor 7 or the information processing device 1. For example, reducing the power supplied to the unused parts while preserving a value of a register minimally required within the processor 7 is the same as above, but there are many processors having a first wait state in which the power of a cache memory is turned on and data is held, and further having a second wait state, called a deep sleep, in which the power of the cache memory is turned off and data is not held.

A suspended state is a state in which information necessary for recovering the operating state of the processor 7 or the input/output device immediately before suspension is recorded in the nonvolatile main memory 8 (or second storage 9), and the operation is stopped. In this state, the supply of power to the information processing device 1 may be completely stopped. Since the register or the like within the processor 7 or the input/output device is volatile, information is lost when the supply of power is stopped. However, after resuming the supply of power, information necessary for recovering the operating state of the processor 7 or the input/output device is recorded in the nonvolatile main memory 8 (or secondary storage 9). Therefore, the operation may be resumed by recovering the operating state of the processor 7 or the input/output device to a state prior to the suspended state, based on the information. Also, in some cases, slight power is continuously supplied to the processor 7 even in the suspended state. In the relation with the activated state, the suspended state can be defined as a state in which the power consumption of the processor 7 is lower than that in the activated state.

The state control device 12 controls the state transition of the information processing device 1 between the activated state and the suspended state as described above. Specifically, a first power amount P1 and a second power amount P2 are determined based on a power amount Pon necessary for causing the information processing device 1 to transit from the suspended state to the activated state, and based on a power amount Poff necessary for causing the information processing device 1 to transit from the activated state to the suspended state. The first power amount P1 is a power amount that exceeds at least Poff. The second power amount P2 is a power amount that exceeds at least Pon+Poff, and has a value larger than the first power amount P1. The state control device 12 monitors the power amount accumulated in the electric storage unit 5 through the detection unit 11 whenever the information processing device 1 is in the activated state or the suspended state. If the power amount accumulated in the electric storage unit 5 is decreased to the first power amount P1 when the information processing device 1 is in the activated state, the state control device 12 causes the information processing device 1 to transit from the activated state to the suspended state. Also, if the power amount accumulated in the electric storage unit 5 is increased to the second power amount P2 when the information processing device 1 is in the suspended state, the state control device 12 causes the information processing device 1 to transit from the suspended state to the activated state.

FIG. 4 is a diagram describing the relation between the power amount accumulated in the electric storage unit 5 and the state transition of the information processing device 1. In the graph, a vertical axis represents power amount accumulated in the electric storage unit 5, and a horizontal axis represents elapse of time.

In the example illustrated in FIG. 4, at time point T0, the power is not accumulated in the electric storage unit 5, and the information processing device 1 is in the suspended state. Subsequently, the power generated by the solar cell 3 is accumulated in the electric storage unit 5. If the power amount accumulated in the electric storage unit 5 is increased to the second power amount P2 (at T1 in the drawing), the state control device 12 causes the information processing device 1 to transit from the suspended state to the activated state. Subsequently, the information processing device 1 is continuously activated using the power generated by the solar cell 3 and the power accumulated in the electric storage unit 5. However, when the processing load is increased or the power amount of the solar cell 3 is decreased, the power amount accumulated in the electric storage unit 5 is decreased. If the power amount accumulated in the electric storage unit 5 is decreased to the first power amount P1 (at T2 in the drawing), the state control device 12 causes the information processing device 1 to transit from the activated state to the suspended state. Thereafter, if the power generated by the solar cell 3 is accumulated in the electric storage unit 5 and the power amount accumulated in the electric storage unit 5 is increased to the second power amount P2 (at T3 in the drawing), the state control device 12 causes the information processing device 1 to transit from the suspended state to the activated state.

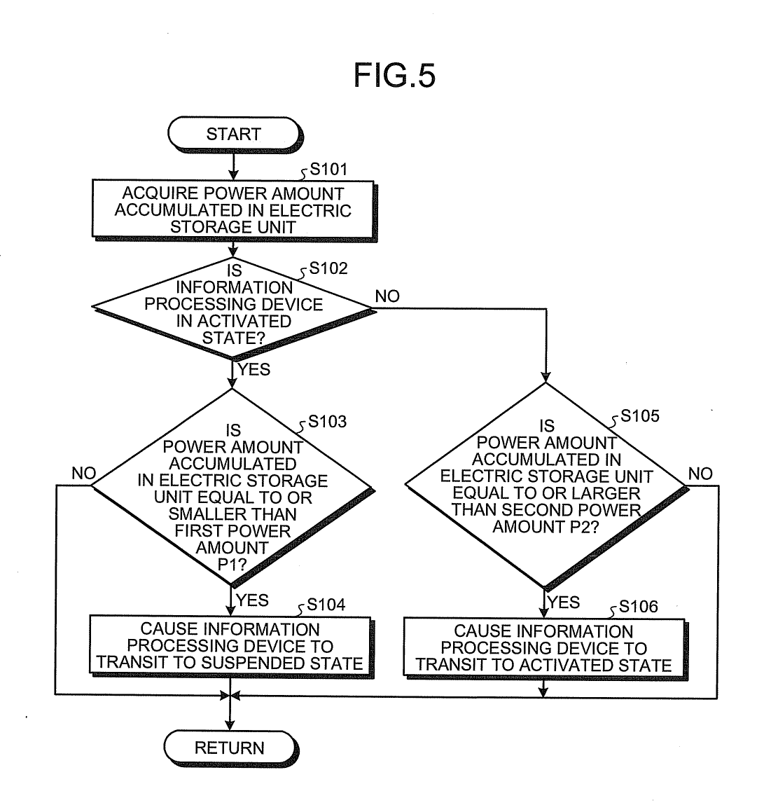

FIG. 5 is a flowchart illustrating processes performed by the state control device 12 for implementing the state transition as illustrated in FIG. 4. The state control device 12 needs to control the power management unit 6 that manages the supply of power to the entire information processing device 1. For this reason, the power necessary for the operation of the state control device 12 is directly supplied from the electric storage unit 5, without passing through the power management unit 6. If the power necessary for the operation is supplied from the electric storage unit 5, the state control device 12 is activated to start the processing illustrated in FIG. 5. Also, while the power is being supplied to the state control device 12, the state control device 12 repetitively executes the processes illustrated in the flowchart of FIG. 5 in, for example, a short period of units of 100 milliseconds.

First, in step S101, the state control device 12 acquires a power amount accumulated in the electric storage unit 5 through the detection unit 11. The state control device 12 controls the state transition of the information processing device 1 according to the power amount acquired in step S101 and the current state of the information processing device 1. That is, the state control device 12 determines whether the information processing device 1 is in the activated state or in the suspended state in step S102. When the information processing device 1 is in the activated state (Yes in step S102), the state control device 12 determines whether the power amount acquired in step S101, that is, the power amount accumulated in the electric storage unit 5 is equal to or smaller than the first power amount P1 in step S103. When the power amount accumulated in the electric storage unit 5 is equal to or smaller than the first power amount P1 (Yes in step S103), the state control device 12 causes the information processing device 1 to transit from the activated state to the suspended state in step S104 and returns. On the other hand, when the power amount accumulated in the electric storage unit 5 exceeds the first power amount P1 (No in step S103), the state control device 12 returns without changing the state of the information processing device 1.

Also, when the information processing device 1 is in the suspended state (No in step S102), the state control device 12 determines whether the power amount acquired in step S101, that is, the power amount accumulated in the electric storage unit 5 is equal to or larger than the second power amount P2 in step S105. When the power amount accumulated in the electric storage unit 5 is equal to or larger than the second power amount P2 (Yes in step S105), the state control device 12 causes the information processing device 1 to transit from the suspended state to the activated state in step S106 and returns. On the other hand, when the power amount accumulated in the electric storage unit 5 is smaller than the second power amount P2 (No in step S105), the state control device 12 returns without changing the state of the information processing device 1. Herein, returning points to returning to the operation in step S101 of the next cycle.

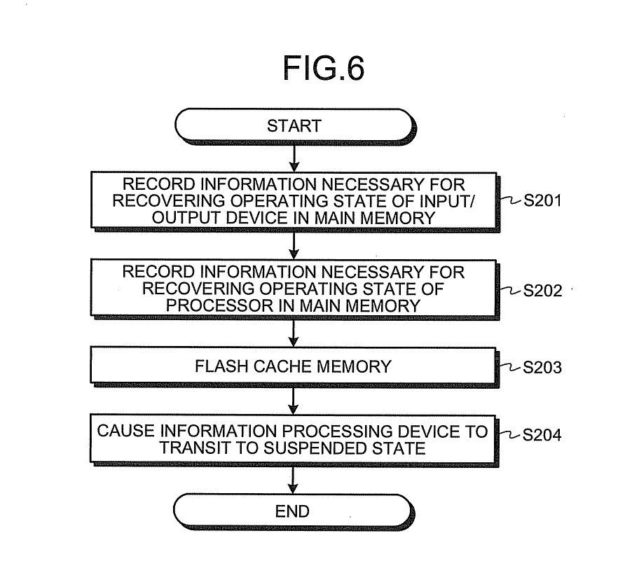

A process of causing the state control device 12 to transit the information processing device 1 from the activated state to the suspended state, for example, may be implemented in such a manner that the state control device 12 generates an interrupt instructing the processor 7 to transit to the suspended state, and the processor 7 receiving the interrupt performs the operation illustrated in FIG. 6. FIG. 6 is a flowchart illustrating the operation of the processor 7 when receiving the suspension instruction.

When the processor 7 receives the interrupt instructing the transition to the suspended state from the state control device 12, first, the processor 7 records information necessary for recovering the operating state of the input/output device being currently operating in the nonvolatile main memory 8 in step S201. The information necessary for recovering the operating state refers to information necessary for resuming the process suspended when becoming the suspended state, in the case where the information processing device 1 returns later from the suspended state to the activated state. For example, while reading data from the secondary storage 9, if information on an address of data being read and a data length is recorded in the main memory 8, the information processing device 1 can execute the same reading process again when the information processing device 1 returns later from the suspended state to the activated state. Likewise, while writing data in the secondary storage 9, if data to be written and information on an address of write destination are recorded in the main memory 8, the information processing device 1 can execute the same writing process again when the information processing device 1 returns later from the suspended state to the activated state. Also, while writing data to the display unit 2a, the data to be written and the information on write destination are recorded in the main memory 8.

Meanwhile, in the case where the processor 7 is configured to receive the interrupt instructing the transition to the suspended state from the state control device 12 when the first power amount P1 is set to a value sufficiently larger than Poff described above, that is, in a state that the power amount sufficiently larger than Poff described above is accumulated in the electric storage unit 5, the processor 7 may not perform step S201 and wait until the input and output operations of the input/output device being currently operating is completed.

Also, when the input and output operations of the input/output device is started, the processor 7 may require the state control device 12 to check the power amount accumulated in the electric storage unit 5 so as to check whether the power amount (estimated value) necessary for completing the input output operations of the input/output device is accumulated in the electric storage unit 5, and then start the input and output operations of the input/output device. That is, when the power amount accumulated in the electric storage unit 5 at a timing when the input/output device starts the input and output operations is enough to complete the input and output operations of the input/output device, the input and output operations of the input/output device are started. When the power amount accumulated in the electric storage unit 5 is not enough, the input and output operations of the input/output device are waited. By performing such a control, it is possible to remove the input/output device being operating when the information processing device 1 transits from the activated state to the suspended state.

Subsequently, the processor 7 records information necessary for recovering the operating state of the processor 7 in the main memory 8 in step S202. That is, since the operating state of the processor 7 is determined by an internal register, a necessary value of a register is recorded in an area on the nonvolatile main memory 8.

Also, when the information processing device 1 transits to the suspended state and a supply of power is stopped, data of the cache memory is lost. Therefore, the processor 7 flashes the cache memory in step S203, and dirty data of the cache memory is written in the main memory 8 so as not to be lost.

Subsequently, the information processing device 1 is caused to transit from the activated state to the suspended state in step S204. The method of causing the information processing device 1 to transit to the suspended state may be performed in such a manner that the processor 7 instructs the power management unit 6 to stop the supply of power to the respective parts of the information processing device 1, or the state control device 12 instructs the power management unit 6 to stop the supply of power to the respective parts of the information processing device 1.

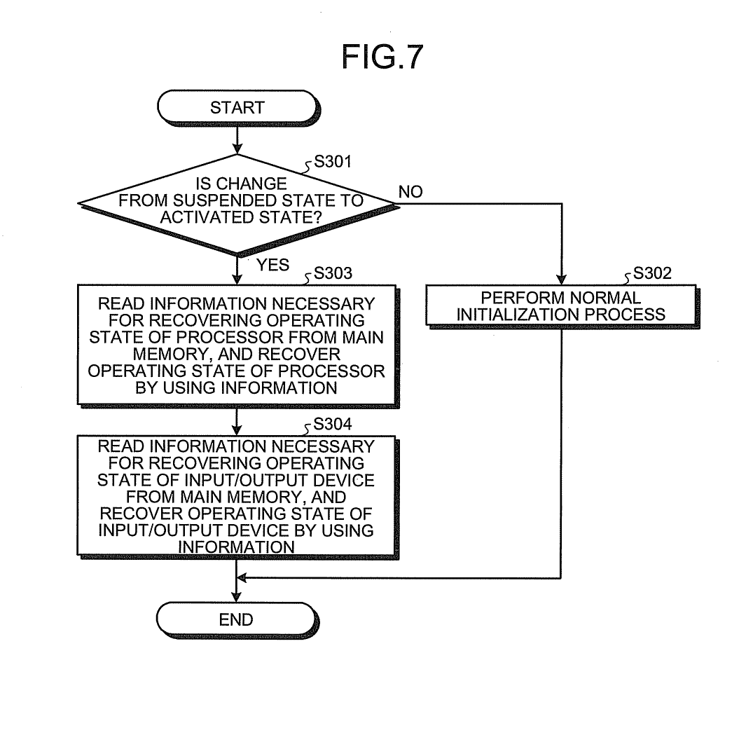

A process of causing the state control device 12 to transit the information processing device 1 from the suspended state to the activated state, for example, may be implemented in such a manner that the state control device 12 instructs the power management unit 6 to activate the system through a signal line, such as I2C or GPIO, and the power management unit 6 receiving the instruction supplies power to the respective parts of the information processing device 1 and performs resetting process. FIG. 7 is a flowchart illustrating the operation of the processor 7 after the resetting process.

The processor 7 after the resetting process, first, determines whether the state is changed from the suspended state to the activated state in step S301. This determination, for example, may be implemented in such a manner that the processor 7 writes a specific value in a specific area of the nonvolatile main memory 8 when the processor 7 causes the information processing device 1 to transit from the activated state to the suspended state according to the operation flow of FIG. 6, and determines whether the specific value is written in the specific area of the main memory 8 in step S301.

When it is determined in step S301 that the state is not changed from the suspended state to the activated state, that is, when it is determined that it is a normal boot operation by a press of a power button or the like (No in step S301), the processor 7 executes a normal initialization process in step S302. The normal initialization process is, for example, startup process of the operating system.

On the other hand, when it is determined that the state is changed from the suspended state to the activated state (Yes in step S301), the processor 7 reads information necessary for recovering the operating state of the processor 7 from the main memory 8, and recovers the operating state of the processor 7 by using the information in step S303. This process may be implemented by restoring the value of the register, which is recorded on the main memory 8.

Subsequently, the processor 7 reads information necessary for recovering the operating state of the input/output device, which is suspended upon transition from the activated state to the suspended state, from the main memory 8, and recovers the operating state of the input/output device by using the information in step S304. For example, in the case of reading data from the secondary storage 9, the process of reading data of the recorded data length from the recorded address on the secondary storage 9 is re-executed in the input/output device.

The power amount Pon necessary for causing the information processing device 1 to transit from the suspended state to the activated state may be defined as the total power consumption of the information processing device 1 consumed during execution of step S301, step S303, and step S304 of FIG. 7. Also, the power amount Poff necessary for causing the information processing device 1 to transit from the activated state to the suspended state may be defined as the total power consumption of the information processing device 1 consumed during execution of steps S201 to step S204 of FIG. 6. It is apparent that since there is a variation in these power consumptions, the value of Pon or Poff is set in advance based on the maximum power consumption assumed in the system. Then, the first power amount P1, which becomes a threshold value at which the information processing device 1 is caused to transit from the activated state to the suspended state, is set to a power amount exceeding at least Poff. Also, the second power amount P2, which becomes a threshold value at which the information processing device 1 is caused to transit from the suspended state to the activated state, is set to a power amount exceeding at least Pon+Poff.

As described above, the information processing device 1 of the first embodiment is a peak assist type information processing device 1 that compensates for the lack of the power generated by the solar cell 3 by the power accumulated in the electric storage unit 5. In the information processing device 1, the state control device 12 monitors the power amount accumulated in the electric storage unit 5. When the power amount accumulated in the electric storage unit 5 in the activated state is decreased to the first power amount P1, the state control device 12 causes the information processing device 1 to transit from the activated state to the suspended state. When the power amount accumulated in the electric storage unit 5 in the suspended state is increased to the second power amount P2, the state control device 12 causes the information processing device 1 to transit from the suspended state to the activated state.

Therefore, without the user's awareness, the information processing device 1 can perform the following operation: the information processing device 1 is caused to transit to the suspended state if the power amount accumulated in the electric storage unit 5 is insufficient because the power generation of the solar cell 3 is stopped while the information processing device 1 is being put in a bag or a drawer, and then, the information processing device 1 is taken out of in a bright place to allow the solar cell 3 to generate sufficient power, and, if the power amount accumulated in the electric storage unit 5 increases, the information processing device 1 returns to the activated state. Also, it seems to the user as if the information processing device 1 continuously performs the processing, because when the processing load by the processor 7 is likely to exceed the power generation capability of the solar cell 3, the information processing device 1 is repeatedly placed in the suspended state and the activated state at a short time interval so as not to be sensed by the user. As such, the information processing device 1 of the first embodiment can perform the appropriate state transition according to usage environment, without the user's awareness.

In the case where the information processing device is operated using power generation by solar cells, energy harvesting by heat or vibration, wireless power feeding, human power generation by a hand-turned wheel, supply of power by a wired manner such as a USB, or the like, it is difficult to continuously supply sufficient power stably. Therefore, a peak power assist is required. That is, in the information processing device of this type, since the power consumption in the active state (state in which the processor is executing the processing) may be increased more than the supplied power amount, surplus power is accumulated in the electric storage unit, such as a capacitor or a battery, during the wait state (state in which the processor waits for the interrupt from the input/output device) or the suspended state (state in which the supply of power is stopped and the entire operation of the information processing device is stopped), and the power is used in the activated state.

It is expected that, without the user's awareness, the peak assist type information processing device can perform the operation that enters the suspended state while maintaining the operating state of the processor or the input/output device, when the supplied power is insufficient, or when the supply of power is stopped, and then, returns to the activated state and resumes the operation when the power necessary for operating in the activated state (state in which the active state and the wait state are repeated) is accumulated in the electric storage unit.

For example, the tablet terminal driven by the solar cell is required to perform the operations of changing the tablet terminal to the suspended state when it is likely that the power accumulated in the electric storage unit lost while being put in a bag or a drawer, and returning the tablet terminal to the activated state when the tablet terminal is taken out in a bright place, without the user's awareness. Also, when the processing load is likely to exceed the power generation capability of the solar cell, it is required to show the user as if the processing is continuously performed by repeating the suspended state and the activated state at a short time interval so as to making the user unaware of it.

As in the conventional art, the operation of such an information processing device cannot be realized by just stopping the supply of power to the unused parts. Also, if the power amount accumulated in the electric storage unit is insufficient, the operation cannot be realized by just suspending the information processing device.

In contrast, in the information processing device 1, the state control device 12 monitors the power amount accumulated in the electric storage unit 5. When the power amount accumulated in the electric storage unit 5 in the activated state is decreased to the first power amount P1, the state control device 12 causes the information processing device 1 to transit from the activated state to the suspended state. When the power amount accumulated in the electric storage unit 5 in the suspended state is increased to the second power amount P2, the state control device 12 causes the information processing device 1 to transit from the suspended state to the activated state. Therefore, it is possible to realize an appropriate state transition according to usage environment, without the user's awareness.

### Second Embodiment

Next, an information processing device according to a second embodiment will be described. The information processing device according to the second embodiment is an example that uses, in a main memory 8, a volatile memory such as DRAM, not a nonvolatile memory such as MRAM. The basic configuration of the information processing device is identical to that of the first embodiment. Therefore, hereinafter, the same reference numerals are assigned to the elements common with the first embodiment, and a redundant description will not be provided. Only characteristic parts of the second embodiment will be described. Also, in order to discriminate from the first embodiment, an information processing device, a main memory, a power management unit, and a state control device according to the second embodiment are referred to as an information processing device 1′, a main memory 8′, a power management unit 6′, and a state control device 12′. Also, in the description of the second embodiment, a first power amount that becomes a threshold value at which the information processing device 1′ is caused to transit from an activated state to a suspended state is referred to as a first power amount P1′, and a second power amount that becomes a threshold value at which the information processing device 1′ is caused to transit from a suspended state to an activated state is referred to as a second power amount P2′.

Since the information processing device 1′ of the second embodiment uses a volatile memory in the main memory 8′, data of the main memory 8′ disappears if the supply of power of the entire information processing device 1′ is stopped in the suspended state. Therefore, the power management unit 6′ capable of continuously supplying power to the main memory 8′ even in the suspended state is used, and the state control device 12′ controls the information processing device 1 such that the information processing device is caused to transit from the activated state to the suspended state under such a state that the power amount enough to continuously supplying power to the main memory 8′ is left in the electric storage unit 5 for a predetermined time after the information processing device 1′ transits to the suspended state.

Specifically, a power amount Psave necessary to retain data stored in the main memory 8′ for a predetermined time is calculated in advance. Based on Pon, Poff, and Psave described above, the first power amount P1′ that becomes the threshold value at which the information processing device 1′ is caused to transit from the activated state to the suspended state is set to a power amount exceeding at least Poff+Psave. Also, the second power amount P2′ that becomes the threshold value at which the information processing device 1′ is caused to transit from the suspended state to the activated state is set to a power amount exceeding at least Pon+Poff+Psave.

As with the state control device 12 of the first embodiment, the state control device 12′ monitors the power amount accumulated in the electric storage unit 5 through a detection unit 11 whenever the information processing device 1′ is in the activated state or the suspended state. If the power amount accumulated in the electric storage unit 5 is decreased to the first power amount P1′ when the information processing device 1′ is in the activated state, the state control device 12′ causes the information processing device 1′ to transit from the activated state to the suspended state. Also, if the power amount accumulated in the electric storage unit 5 is increased to the second power amount P2′ when the information processing device 1′ is in the suspended state, the state control device 12′ causes the information processing device 1′ to transit from the suspended state to the activated state.

Since the state control device 12′ controls the state transition between the activated state and the suspended state as described above, the information processing device 1 of the second embodiment can perform an appropriate state transition according to usage environment, without the user's awareness, as with the information processing device 1 of the first embodiment. Also, since the information processing device 1′ of the second embodiment can retain the operating state of the processor 7 or the input/output device for a predetermined time, without using a nonvolatile memory in the main memory 8′, the main memory 8′ can be configured using a relatively cheap volatile memory. Therefore, component cost can be reduced.

### Third Embodiment

Next, an information processing device according to a third embodiment will be described. In the information processing device 1′ of the second embodiment, if the power generation by the solar cell 3 is stopped for more than a predetermined period of time and thus the power amount accumulated in the electric storage unit 5 becomes zero, the supply of power to the volatile main memory 8′ is cut off and therefore the operating state of the processor 7 or the input/output device may not be retained. Therefore, before the power amount accumulated in the electric storage unit 5 becomes zero, the information processing device of the third embodiment saves data of the volatile main memory 8′ into the nonvolatile secondary storage 9. The basic configuration of the information processing device is identical to that of the first embodiment or the second embodiment. Therefore, hereinafter, the same reference numerals are assigned to the elements common with the first embodiment or the second embodiment. A redundant description will not be repeated, and only characteristic parts of the third embodiment will be described. Also, in order to discriminate from the first embodiment or the second embodiment, an information processing device and a state control device according to this embodiment are referred to as an information processing device 1″ and a state control device 12″.

In the third embodiment, in addition to the first power amount P1′ and the second power amount P2′, a third power amount P3 and a fourth power amount P4 are determined. The third power amount P3 is a power amount that exceeds a power amount necessary for saving at least the data of the volatile main memory 8′ into the secondary storage 9, and has a value less than the first power amount P1′. Also, the fourth power amount P4 is a power amount that exceeds a power amount necessary for restoring at least the data of the main memory 8′, which was saved into the secondary storage 9, to the main memory 8′, and has a value smaller than the second power amount P2′.

As with the state control device 12′ of the second embodiment, the state control device 12″ monitors the power amount accumulated in the electric storage unit 5 through the detection unit 11 when the information processing device 1″ is in the activated state or the suspended state. If the power amount accumulated in the electric storage unit 5 is decreased to the first power amount P1′ when the information processing device 1″ is in the activated state, the state control device 12 causes the information processing device 1″ to transit from the activated state to the suspended state. Subsequently, if the supply of power to the main memory 8′ is continued in such a state that the solar cell 3 does not generate power, and thus, the power amount accumulated in the electric storage unit 5 is further decreased and the power amount accumulated in the electric storage unit 5 is decreased to the third power amount P3, the state control device 12″ saves the data of the main memory 8′ into the secondary storage 9.

Subsequently, if the power obtained by the power generation of the solar cell 3 when the information processing device 1″ is in the suspended state is accumulated in the electric storage unit 5 and thus the power amount accumulated in the electric storage unit 5 is increased to the fourth power amount P4, the state control device 12″ restores the data of the main memory 8′, which was saved into the secondary storage 9, to the main memory 8′. Subsequently, if the power amount accumulated in the electric storage unit 5 by the power generation of the solar cell 3 is further increased to the second power amount P2′, the state control device 12″ causes the information processing device 1″ to transit from the suspended state to the activated state.

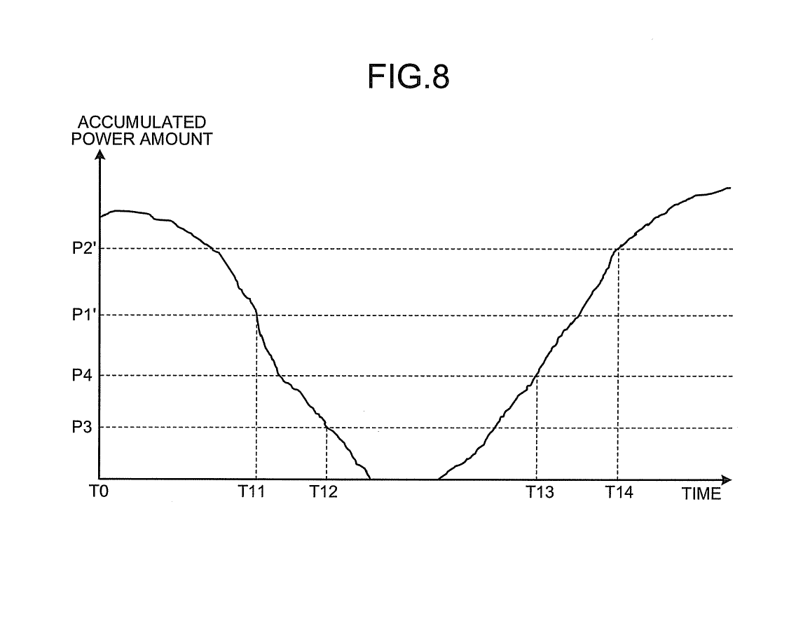

FIG. 8 is a diagram describing the relation between the power amount accumulated in the electric storage unit 5 and the state transition of the information processing device 1″. In the graph, a vertical axis represents the power amount accumulated in the electric storage unit 5, and a horizontal axis represents elapse of time.

In the example illustrated in FIG. 8, at time point T0, sufficient power is accumulated in the electric storage unit 5, and the information processing device 1″ is in the activated state. The information processing device 1″ is continuously activated using the power generated by the solar cell 3 and the power accumulated in the electric storage unit 5. However, when the processing load of the processor 7 is increased or the power generation amount of the solar cell 3 is decreased, the power amount accumulated in the electric storage unit 5 is reduced. If the power amount accumulated in the electric storage unit 5 is decreased to the first power amount P1′ (at T11 in the drawing), the state control device 12″ causes the information processing device 1″ to transit from the activated state to the suspended state. Subsequently, the main memory 8′ backs up data by the power accumulated in the electric storage unit 5. However, if the power amount accumulated in the electric storage unit 5 is decreased to the third power amount P3 (at T12 in the drawing), the state control device 12″ saves the data of the main memory 8′ into the secondary storage 9. Subsequently, even when the supply of power to the main memory 8′ is cut off, information necessary for restoring the operating state of the processor 7 or the input/output device is recorded in the secondary storage 9. Thus, the operating state of the processor 7 or the input/output device is retained.

Subsequently, if the power generated by the solar cell 3 is accumulated in the electric storage unit 5, and the power amount accumulated in the electric storage unit 5 is increased to the fourth power amount P4 (at T13 in the drawing), the state control device 12″ restores the data of the main memory 8′, which was saved into the secondary storage 9, to the main memory 8′. Furthermore, subsequently, if the power amount accumulated in the electric storage unit 5 is increased to the second power amount P2′ (T14 in the drawing), the state control device 12 causes the information processing device 1″ to transit from the suspended state to the activated state.

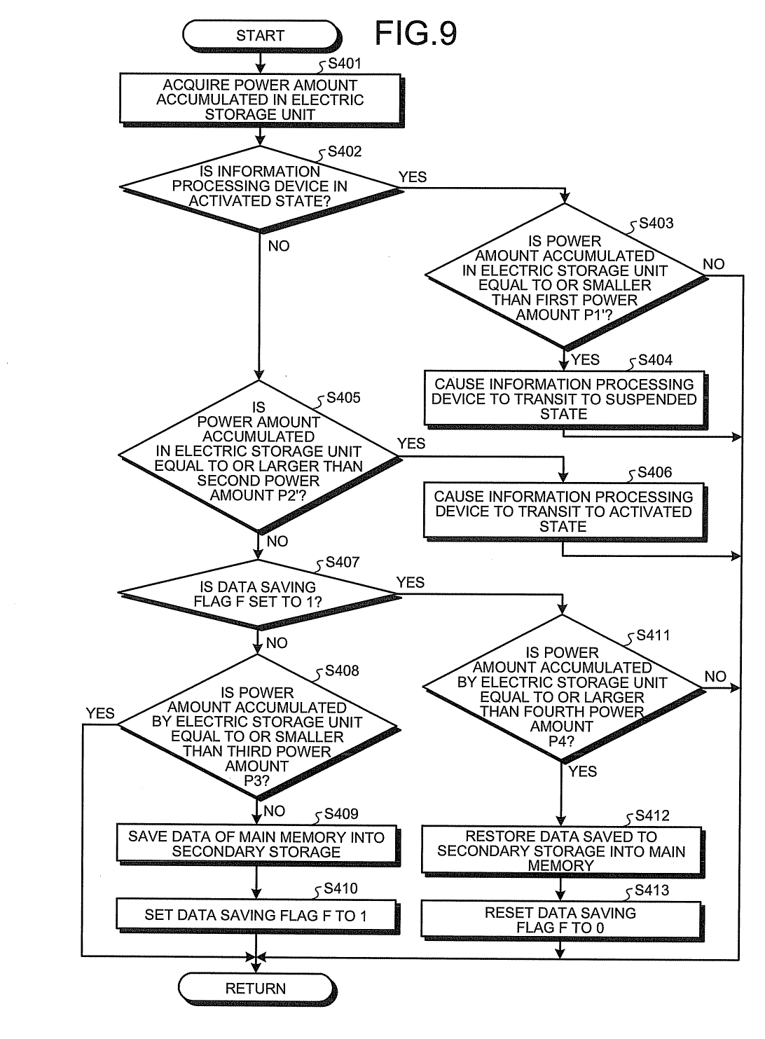

FIG. 9 is a flowchart illustrating the processes performed by the state control device 12″ for implementing the state transition as illustrated in FIG. 8. When the power necessary for the operation is supplied from the electric storage unit 5, the state control device 12″ is activated to start the processes illustrated in FIG. 9. Also, while the power is being supplied to the state control device 12″, the state control device 12″ repetitively executes the processes illustrated in the flowchart of FIG. 9 in, for example, a short period of units of 100 milliseconds.

First, in step S401, the state control device 12″ acquires a power amount accumulated in the electric storage unit 5 through the detection unit 11. Subsequently, the state control device 12″ determines whether the information processing device 1″ is in the activated state or in the suspended state in step S402. When the information processing device 1″ is in the activated state (Yes in step S402), the state control device 12″ determines whether the power amount acquired in step S401, that is, the power amount accumulated in the electric storage unit 5 is equal to or smaller than the first power amount P1′ in step S403. When the power amount accumulated in the electric storage unit 5 is equal to or smaller than the first power amount P1′ (Yes in step S403), the state control device 12″ causes the information processing device 1″ to transit from the activated state to the suspended state in step S404 and returns. On the other hand, when the power amount accumulated in the electric storage unit 5 exceeds the first power amount P1′ (No in step S403), the state control device 12″ returns without changing the state of the information processing device 1″.

Also, when the information processing device 1″ is in the suspended state (No in step S402), the state control device 12″ determines whether the power amount accumulated in the electric storage unit 5 is equal to or larger than the second power amount P2′ in step S405. When the power amount accumulated in the electric storage unit 5 is equal to or larger than the second power amount P2′ (Yes in step S405), the state control device 12″ causes the information processing device 1″ to transit from the suspended state to the activated state in step S406 and returns. On the other hand, when the power amount accumulated in the electric storage unit 5 is smaller than the second power amount P2 (No in step S405), the state control device 12″ checks a data saving flag F indicating whether the data of the main memory 8′ is saved into the secondary storage 9 in step S407. The data saving flag F is 1-bit data recorded in a predetermined area of the nonvolatile memory such as the secondary storage 9. When ‘1’ is set, the data saving flag F represents the state in which the data of the main memory 8′ is saved into the secondary storage 9. Also, by embedding a nonvolatile memory into the state control device 12″, 1-bit data recorded in the predetermined area of the nonvolatile memory may be used as the data saving flag F.

When it is determined in step S407 that the data saving flag F is not set to ‘1’ (No in step S407), the state control device 12″ determines whether the power amount accumulated in the electric storage unit 5 is equal to or smaller than the third power amount P3 in step S408. When the power amount accumulated in the electric storage unit 5 exceeds the third power amount P3 (No in step S408), the state control device 12″ saves the data of the main memory 8′ into the secondary storage 9 in step S409, sets the data saving flag F to ‘1’ in step S410, and returns. On the other hand, when it is determined in step S408 that the power amount accumulated in the electric storage unit 5 is equal to or smaller than the third power amount P3 (Yes in step S408), the state control device 12″ returns without executing the process of step S409 and step S410.

Also, when the information processing device 1″ is in the suspended state and it is determined that the data saving flag F is set to ‘1’ (Yes in step S407), the state control device 12″ determines whether the power amount accumulated in the electric storage unit 5 is equal to or larger than the fourth power amount P4 in step S411. When the power amount accumulated in the electric storage unit 5 is smaller than the fourth power amount P4 (No in step S411), the state control device 12″ returns without changing the state of the information processing device 1″. On the other hand, when the power amount accumulated in the electric storage unit 5 is equal to or larger than the fourth power amount P4 (Yes in step S411), the state control device 12″ restores the data of the main memory 8′, which was saved into the secondary storage 9, into the main memory 8′ in step S412, resets the data saving flag F to ‘0’ in step S413, and returns. Herein, returning points to returning to the operation in step S401 of the next cycle.

Meanwhile, the explanation given above is for an example in which the data of the main memory 8′ is saved into the secondary storage 9 before the power amount accumulated in the electric storage unit 5 becomes equal to or smaller than third power amount P3. However, alternatively, the data of the main memory 8′ can be saved into the secondary storage 9 after the power amount accumulated in the electric storage unit 5 becomes equal to or smaller than third power amount P3.

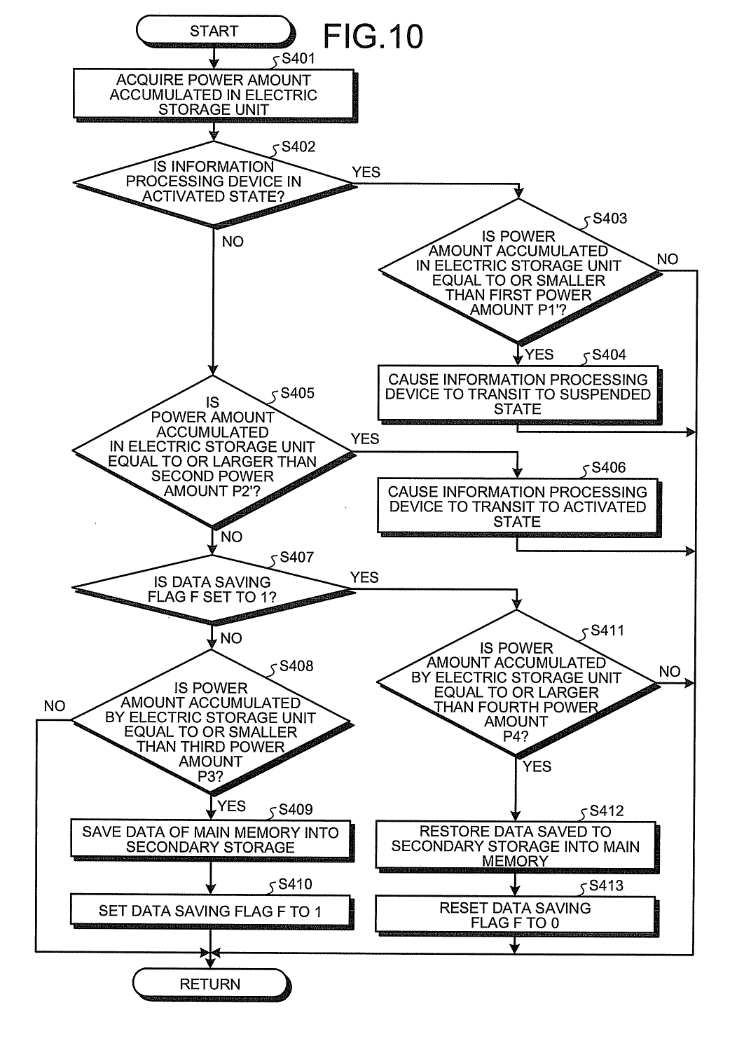

FIG. 10 is a flowchart illustrating the processes performed by the state control device 12″ for implementing the state transition in the case when the data of the main memory 8′ is saved into the secondary storage 9 after the power amount accumulated in the electric storage unit 5 becomes equal to or smaller than third power amount P3. As compared to the flowchart illustrated in FIG. 9, the flowchart illustrated in FIG. 10 differs in the branching performed according to the determination result in step S408. That is, in the example illustrated in FIG. 10, when it is determined in step S407 that the data saving flag F is not set to ‘1’ (No in step S407), then the state control device 12″ determines whether the power amount accumulated in the electric storage unit 5 is equal to or smaller than the third power amount P3 in step S408. When it is determined that the power amount accumulated in the electric storage unit 5 is equal to or smaller than the third power amount P3 (Yes in step S408), then the state control device 12″ saves the data of the main memory 8′ into the secondary storage 9 in step S409; sets the data saving flag F to ‘1’ in step S410; and returns. On the other hand, when it is determined in step S408 that the power amount accumulated in the electric storage unit 5 is larger than the third power amount P3 (No in step S408), then the state control device 12″ returns without executing the processes in step S409 and step S410. Herein, returning points to returning to the operation in step S401 of the next cycle.

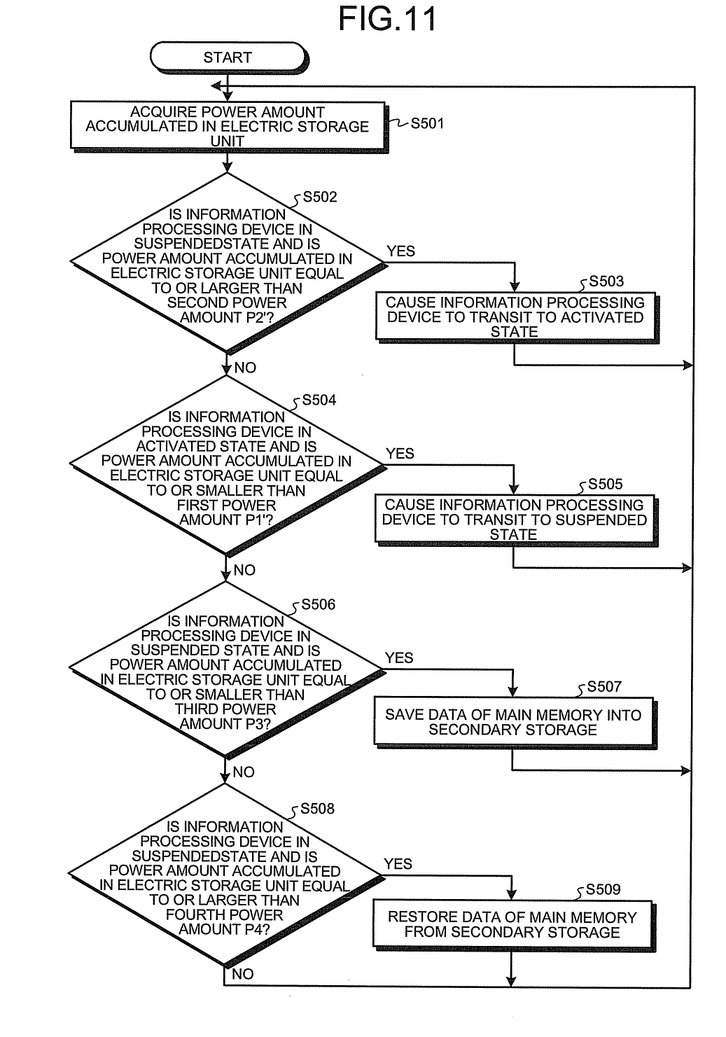

Meanwhile, instead of performing the processes illustrated in the flowchart in FIG. 9 or performing the processes illustrated in the flowchart in FIG. 10, the state control device 12″ can alternatively perform processes illustrated in a flowchart in FIG. 11. Herein, while the power is being supplied to the state control device 12″, the state control device 12″ repetitively executes the processes illustrated in the flowchart of FIG. 11 in, for example, a short period of units of 100 milliseconds.

First, in step S501, the state control device 12″ acquires a power amount accumulated in the electric storage unit 5 through the detection unit 11. Subsequently, the state control device 12″ determines whether or not the information processing device 1″ is in the suspended state and the power amount accumulated in the electric storage unit 5 is equal to or larger than the second power amount P2′ in step S502. When the information processing device 1″ is in the suspended state and the power amount accumulated in the electric storage unit 5 is equal to or larger than the second power amount P2′ (Yes in step S502), then the state control device 12″ causes the information processing device 1 to transit from the suspended state to the activated state in step S503, and returns. Herein, returning points to returning to the operation in step S501 of the next cycle.

On the other hand, when the information processing device 1″ is not in the suspended state or when the power amount accumulated in the electric storage unit 5 is not equal to or larger than the second power amount P2′ in (No in step S502), the state control device 12″ determines whether or not the information processing device 1″ is in the activated state and the power amount accumulated in the electric storage unit 5 is equal to or smaller than the first power amount P1′ in step S504. When the information processing device 1″ is in the activated state and the power amount accumulated in the electric storage unit 5 is equal to or smaller than the first power amount P1′ (Yes in step S504), then the state control device 12″ causes the information processing device 1 to transit from the activated state to the suspended state in step S505, and returns.

On the other hand, when the power amount accumulated in the electric storage unit 5 is not equal to or smaller than the first power amount P1′ (No in step S504), then the state control device 12″ determines whether or not the information processing device 1″ is in the suspended state and the power amount accumulated in the electric storage unit 5 is equal to or smaller than the third power amount P3 in step S506. When it is determined that the information processing device 1″ is in the suspended state and the power amount accumulated in the electric storage unit 5 is equal to or smaller than the third power amount P3 (Yes in step S506); if the data of the main memory 8′ has not been saved into the secondary storage 9, the state control device 12″ saves the data of the main memory 8′ into the secondary storage 9 in step S507, and returns.

On the other hand, when it is determined that the power amount accumulated in the electric storage unit 5 is not equal to or smaller than the third power amount P3 (No in step S506), then, the state control device 12″ determines whether or not the information processing device 1″ is in the suspended state and the power amount accumulated in the electric storage unit 5 is equal to or larger than the fourth power amount P4 in step S508. When it is determined that the information processing device 1″ is in the suspended state and the power amount accumulated in the electric storage unit 5 is equal to or larger than the fourth power amount P4 (Yes in step S508); if the data of the main memory 8′ is not yet restored from the secondary storage 9, the state control device 12″ restores the data of the main memory 8′ from the secondary storage 9 in step S509, and returns to step S501. On the other hand, when it is determined that the power amount accumulated in the electric storage unit 5 is not equal to or larger than the fourth power amount P4 (No in step S508), the state control device 12 returns without any changes.

Since the state control device 12″ controls the state transition between the activated state and the suspended state as described above, the information processing device 1″ of the third embodiment can perform an appropriate state transition according to usage environment, without the user's awareness, as with the information processing device 1 of the first embodiment and the information processing device 1′ of the second embodiment. Also, as with the information processing device 1′ of the second embodiment, the information processing device 1″ of the third embodiment can configure the main memory 8′ by using a relatively cheap volatile memory. Therefore, component cost can be reduced. In addition, even when the power generation by the solar cell 3 is cut off for a long period of time during the suspended state, the information processing device 1″ of the third embodiment can continuously retain the operating state of the processor 7 or the input/output device. When changed to the activated state, the information processing device 1″ of the third embodiment can recover the operating state of the processor 7 or the input/output device.

Meanwhile, the information processing device 1″ of the third embodiment recovers the data of the main memory 8′, which was saved into the secondary storage 9, into the main memory 8′, at a point of time when the power amount accumulated in the electric storage unit 5 is increased to the fourth power amount P4. However, at a point of time when the power amount accumulated in the electric storage unit 5 is increased to the fourth power amount P4, the data of the main memory 8′ may be saved into the secondary storage 9. In a step in which the power amount accumulated in the electric storage unit 5 is increased to the second power amount P2′, the state control device 12″ may recover the data of the main memory 8′, which was saved into the secondary storage 9, into the main memory 8′, and may cause the information processing device 1″ to transit from the suspended state to the activated state.

### Fourth Embodiment

Next, an information processing device according to a fourth embodiment will be described. The information processing device of the fourth embodiment is an example in which even when the power amount accumulated in the electric storage unit 5 is increased to the second power amount P2 (or the second power amount P2′) in the suspended state, the information processing device is not caused to transit to the activated state immediately, and when input data is generated from the keyboard 4 or the touch panel 2b, the communication I/F 10, and the like, the information processing device is caused to transit from the suspended state to the activated state. The basic configuration of the information processing device is identical to the first embodiment to the third embodiment. Therefore, hereinafter, the same reference numerals are assigned to the elements common with the first embodiment to the third embodiment, and a redundant description will not be provided. Only characteristic parts of the fourth embodiment will be described. Also, in order to discriminate from the first embodiment to the third embodiment, an information processing device and a state control device according to the fourth embodiment are referred to as an information processing device 1′″ and a state control device 12′″.

Also, in the first embodiment to the third embodiment, if the power amount accumulated in the electric storage unit 5 is increased to the second power amount P2 (P2′) when the information processing device 1 (1′, 1″) is in the suspended state, the state control device 12 (12′, 12″) causes the information processing device 1 (1′, 1″) to transit from the suspended state to the activated state. However, in many cases, the information processing device 1 (1′, 1″) changed from the suspended state to the activated state does not immediately become the active state in which the processor 7 executes the processing, and the information processing device 1 (1′, 1″) enters the wait state in which the processor 7 waits for the interrupt from the input/output device.

Therefore, in this embodiment, even when the power amount accumulated in the electric storage unit 5 is increased to the second power amount P2 (or the second power amount P2′) when the information processing device 1′″ is in the suspended state, the information processing device 1′″ is not caused to transit from the suspended state to the activated state immediately, and when the generation of input data from the keyboard 4 or the touch panel 2b, the communication I/F 10, and the like, to the information processing device 1′″ is detected, the state control device 12′″ causes the information processing device 1′″ to transit from the suspended state to the activated state. In this manner, unnecessary power consumption can be suppressed by maintaining the suspended state until the processing of the processor 7 is needed, and the processing of the processor 7 can be executed by entering from the suspended state to the active state immediately when the processing of the processor 7 is needed. This function can be easily implemented by using the configuration as illustrated in FIG. 2 in which the state control device 12′″ receives the input data from the keyboard 4 or the touch panel 2b and transfers the input data to the processor 7.

Since the state control device 12′″ controls the state transition between the activated state and the suspended state as described above, the information processing device 1′″ of the fourth embodiment can perform an appropriate state transition according to usage environment, without the user's awareness, as with the information processing devices 1 (1′, 1″) of the first embodiment to the third embodiment. Also, even when the power amount accumulated in the electric storage unit 5 is increased to the second power amount P2 (P2′) in the suspended state, the information processing device 1′″ of the fourth embodiment is not caused to transit to the activated state immediately. Since the information processing device 1′″ is caused to transit to the activated state (active state) when the input data is generated and thus the processing of the processor 7 is needed, unnecessary power consumption can be suppressed.

As described above, according to the embodiments, the appropriate state transition according to usage environment can be realized, without the user's awareness.

Also, the function of the state control device included in the information processing device of this embodiment can be realized by a program, for example, firmware embedded in a low-power-consumption microcomputer, or and software executed by a processor. In this case, the information processing device of this embodiment may realize the function of the state control device by installing the program in advance. The information processing device of this embodiment may realize the function of the state control device by storing the program in a storage medium such as CD-ROM, or distributing the program through a network, and appropriately installing the program in the information processing device.

The program realizing the function of the state control device is appropriately read and executed by the microcomputer of the information processing device or the processor. Accordingly, the function of the state control device is realized in the information processing device.

In the embodiments described above, the state control device 12 of the information processing device 1 controls the state transition of the information processing device 1 according to the power amount accumulated in the electric storage unit 5. However, alternatively, if a semiconductor device (SoC: System on Chip) that includes the processor 7 deactivates or reactivates the processor 7 according to the power amount accumulated in the electric storage unit 5, it is still possible to achieve an equivalent effect to the effect achieved in the embodiments described above. Still alternatively, if a semiconductor device (SoC) that includes the processor 7 controls the power consumption of the processor 7 or the power consumption of itself according to the power amount accumulated in the electric storage unit 5, it is still possible to achieve an equivalent effect to the effect achieved in the embodiments described above. Still alternatively, if a semiconductor device (chip) that controls the processor 7 deactivates or reactivates the processor 7 according to the power amount accumulated in the electric storage unit 5, it is still possible to achieve an equivalent effect to the effect achieved in the embodiments described above. Still alternatively, if a semiconductor device (chip) that is connected to an SoC including the processor 7 controls the power consumption of the processor 7 or the power consumption of the SoC according to the power amount accumulated in the electric storage unit 5, it is still possible to achieve an equivalent effect to the effect achieved in the embodiments described above. In the following description, these examples are explained as modification examples.

### First Modification Example

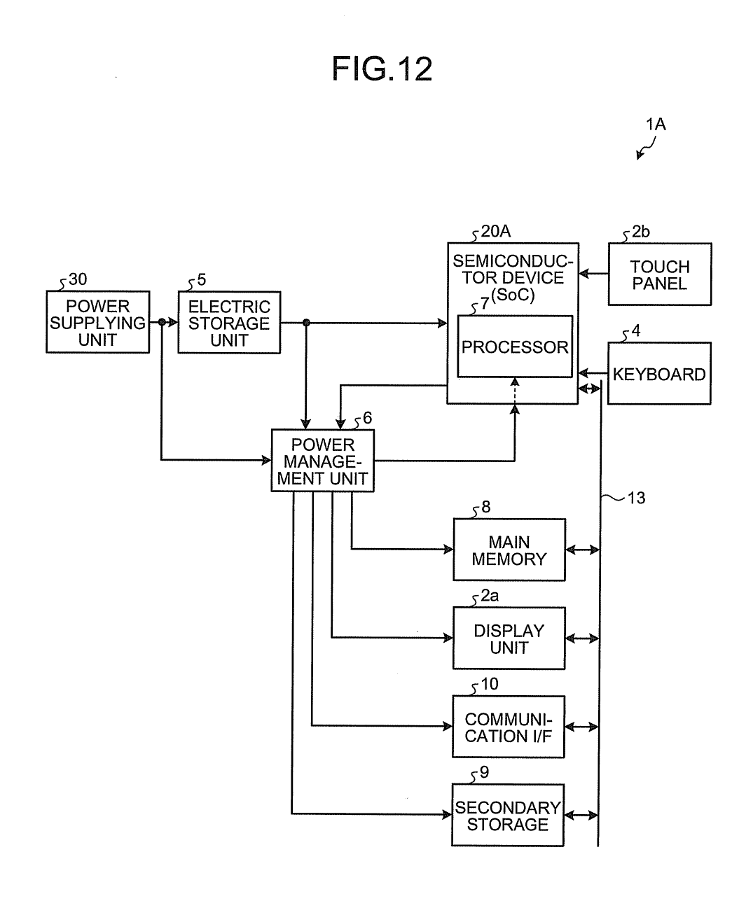

FIG. 12 is a block diagram illustrating a hardware configuration example of an information processing device 1A according to a first modification example. In the information processing device 1A according to the first modification example, the constituent elements identical to those in the information processing device 1 are referred to by the same reference numerals. As illustrated in FIG. 12, the information processing device 1A according to the first modification example includes a semiconductor device 20A that is configured as an SoC which includes the processor 7. Herein, the processor 7 or the semiconductor device 20A receives the supply of power that is accumulated in the electric storage unit 5. The electric storage unit 5 accumulates power that is supplied by a power supplying unit 30. As the power supply unit, the abovementioned solar cell 3 may be used, for example. Meanwhile, apart from including the processor 7, the semiconductor device 20A can also include, for example, the main memory 8.

When the power amount accumulated in the electric storage unit 5 is decreased to the first power amount P1 while the processor 7 is running, the semiconductor device 20A deactivates the processor 7. After deactivating the processor 7, when the power amount accumulated in the electric storage unit 5 is increased to the second power amount P2 that is larger than the first power amount P1, the semiconductor device 20A reactivates the processor 7. Similar to the state transition of the information processing device 1, the processor 7 transits between an activated state and a suspended state. The state in which the processor 7 is running corresponds to the state in which the processor 7 is in the activated state. The state in which the processor 7 is deactivated corresponds to the state in which the processor 7 is in the suspended state. The state in which the processor 7 is reactivated corresponds to the state in which the processor 7 is caused to transit from the suspended state to the activated state.

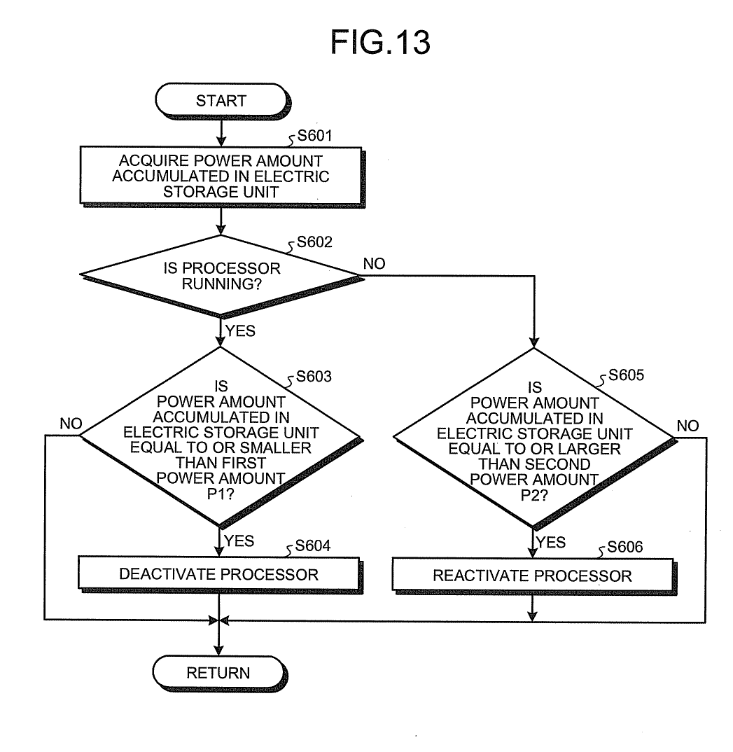

FIG. 13 is a flowchart illustrating processes performed by the semiconductor device 20A. Herein, the semiconductor device 20A repetitively executes the processes illustrated in the flowchart of FIG. 13 in, for example, a short period of units of 100 milliseconds and controls deactivation and reactivation of the processor 7.

First, in step S601, the semiconductor device 20A acquires a power amount accumulated in the electric storage unit 5 through the detection unit 11. Then, the semiconductor device 20A determines whether or not the processor 7 is running in step S602. If the processor 7 is running (Yes in step S602), then the semiconductor device 20A determines whether or not the power amount acquired in step S601, that is, the power amount accumulated in the electric storage unit 5 is equal to or smaller than the first power amount P1 in step S603. If the power amount accumulated in the electric storage unit 5 is equal to or smaller than the first power amount P1 (Yes in step S603), then the semiconductor device 20A deactivates the processor 7 in step S604 and returns to step S601. On the other hand, if the power amount accumulated in the electric storage unit 5 has exceeded the first power amount P1 (No in step S603), the semiconductor device 20A returns to step S601 while keeping the processor 7 running.

Meanwhile, if the processor 7 is not running (No in step S602), then the semiconductor device 20A determines whether or not the power amount acquired in step S601, that is, the power amount accumulated in the electric storage unit 5 is equal to or larger than the second power amount P2 in step S605. If the power amount accumulated in the electric storage unit 5 is equal to or larger than the second power amount P2 (Yes in step S605), then the semiconductor device 20A reactivates the processor 7 in step S606 and returns to step S601. On the other hand, if the power amount accumulated in the electric storage unit 5 is smaller than the second power amount P2 (No in step S605), then the semiconductor device 20A returns to step S601 while keeping the processor 7 deactivated.

As described above, in the information processing device 1A according to the first modification example, the semiconductor device 20A that includes the processor 7 controls the deactivation and reactivation of the processor 7 according to the power amount accumulated in the electric storage unit 5. As a result, the appropriate state transition according to usage environment can be achieved without the user's awareness.

### Second Modification Example

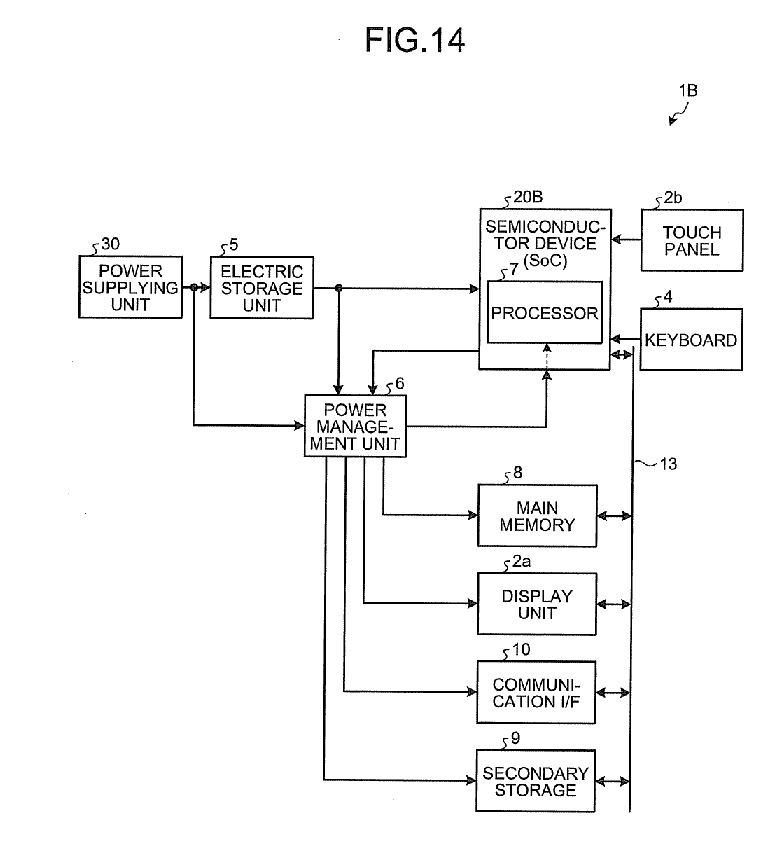

FIG. 14 is a block diagram illustrating a hardware configuration example of an information processing device 1B according to a second modification example. In the information processing device 1B according to the second modification example, the constituent elements identical to those in the information processing device 1 are referred to by the same reference numerals. As illustrated in FIG. 14, in place of the semiconductor device 20A according to the first modification example, the information processing device 1B according to the second modification example includes a semiconductor device 20B. In an identical manner to the semiconductor device 20A according to the first modification example, the semiconductor device 20B is configured as an SoC which includes the processor 7. Herein, the processor 7 or the semiconductor device 20B receives the supply of power that is accumulated in the electric storage unit 5. The electronic storage unit 5 accumulates power that is supplied by a power supplying unit 30. As the power supply unit, the abovementioned solar cell 3 may be used, for example. Meanwhile, apart from including the processor 7, the semiconductor device 20B can also include, for example, the main memory 8.

When the power amount accumulated in the electric storage unit 5 is decreased to the first power amount P1, the semiconductor device 20B reduces the power consumption of itself. In contrast, when the power amount accumulated in the electric storage unit 5 is increased to the second power amount P2 that is larger than the first power amount P1, the semiconductor device 20B increases the power consumption of itself. Herein, reducing the power consumption of the semiconductor device 20B corresponds to the state in which the processor 7 is caused to transit from the activated state to the suspended state. For example, by deactivating the processor 7 that is executing a program, the power consumption of the semiconductor device 20B is reduced. Furthermore, increasing the power consumption of the semiconductor device 20B corresponds to the state in which the processor 7 is caused to transit from the suspended state to the activated state. For example, by reactivating the processor 7 to resume the execution of the program, the power consumption of the semiconductor device 20B is increased.

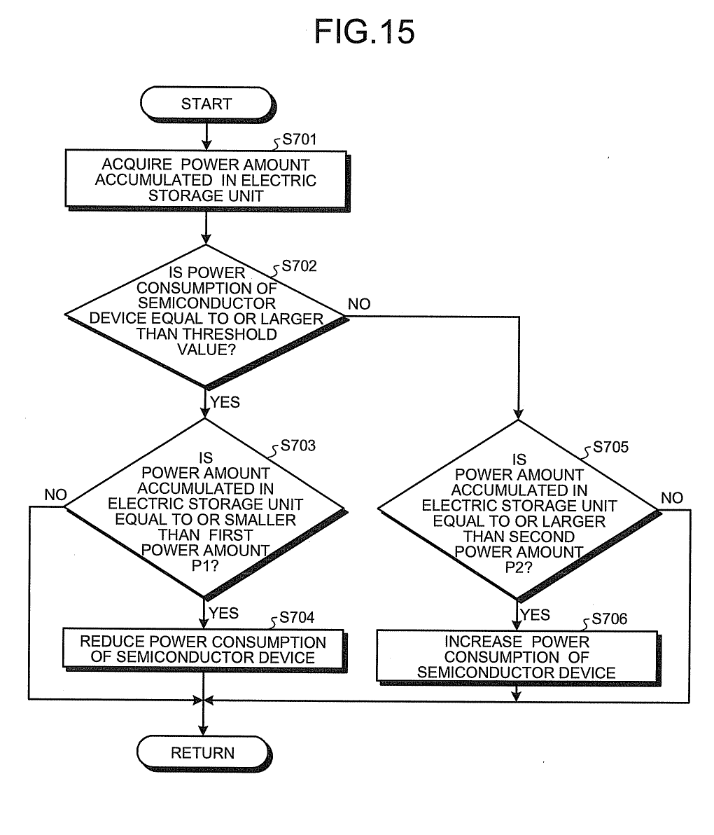

FIG. 15 is a flowchart illustrating processes performed by the semiconductor device 20B. Herein, the semiconductor device 20B repetitively executes the processes illustrated in the flowchart of FIG. 15 in, for example, a short period of units of 100 milliseconds and controls the power consumption of itself.

First, in step S701, the semiconductor device 20B acquires a power amount accumulated in the electric storage unit 5 through the detection unit 11. Then, the semiconductor device 20B determines whether the power consumption thereof is equal to or larger than a predetermined threshold value in step S702. If the power consumption of the semiconductor device 20B is equal to or larger than the predetermined threshold value (Yes in step S702), then the semiconductor device 20B determines whether or not the power amount acquired in step S701, that is, the power amount accumulated in the electric storage unit 5 is equal to or smaller than the first power amount P1 in step S703. If the power amount accumulated in the electric storage unit 5 is equal to or smaller than the first power amount P1 (Yes in step S703), then the semiconductor device 20B reduces the power consumption of itself in step S704 and returns to step S701. On the other hand, if the power amount accumulated in the electric storage unit 5 has exceeded the first power amount P1 (No in step S703), the semiconductor device 20B returns to step S701 without reducing the power consumption of itself.

Meanwhile, if the power consumption of the semiconductor device 20B is smaller than the predetermined threshold value (No in step S702), then the semiconductor device 20B determines whether or not the power amount acquired in step S701, that is, the power amount accumulated in the electric storage unit 5 is equal to or larger than the second power amount P2 in step S705. If the power amount accumulated in the electric storage unit 5 is equal to or larger than the second power amount P2 (Yes in step S705), then the semiconductor device 20B increases the power consumption of itself in step S706 and returns to step S701. On the other hand, if the power amount accumulated in the electric storage unit 5 is smaller than the second power amount P2 (No in step S705), then the semiconductor device 20B returns to step S701 without increasing the power consumption of itself.

As described above, in the information processing device 1B according to the second modification example, the semiconductor device 20B that includes the processor 7 controls the power consumption of itself according to the power amount accumulated in the electric storage unit 5. As a result, the appropriate state transition according to usage environment can be achieved without the user's awareness.

### Third Modification Example

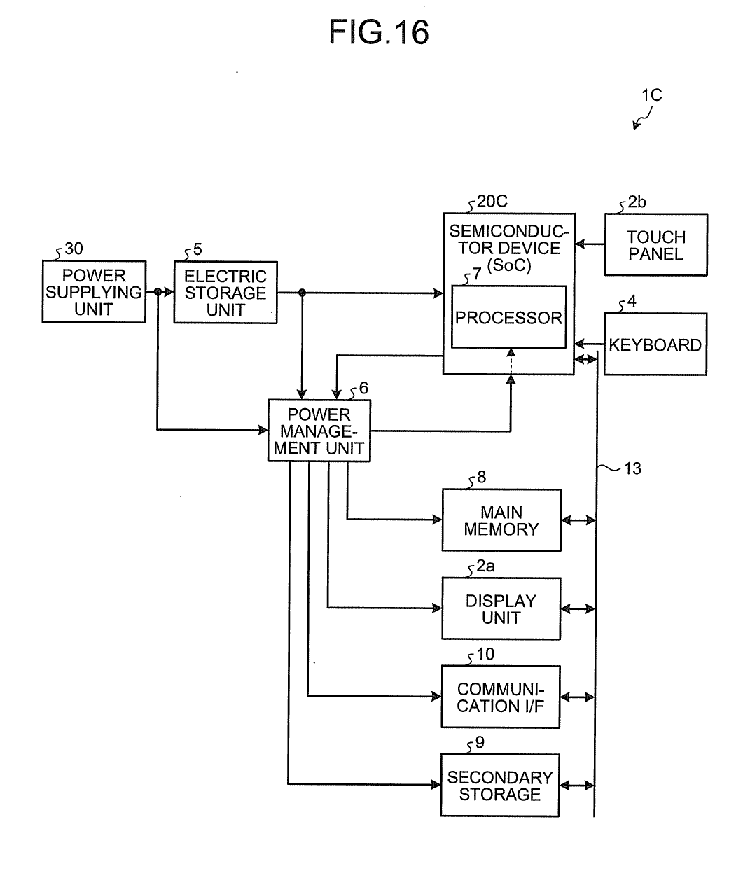

FIG. 16 is a block diagram illustrating a hardware configuration example of an information processing device 1C according to a third modification example. In the information processing device 1C according to the third modification example, the constituent elements identical to those in the information processing device 1 are referred to by the same reference numerals. As illustrated in FIG. 16, in place of the semiconductor device 20A according to the first modification example, the information processing device 1C according to the third modification example includes a semiconductor device 20C. In an identical manner to the semiconductor device 20A according to the first modification example, the semiconductor device 20C is configured as an SoC which includes the processor 7. Herein, the processor 7 receives the supply of power that is accumulated in the electric storage unit 5. The electric storage unit 5 accumulates power that is supplied by a power supplying unit 30. As the power supply unit, the abovementioned solar cell 3 may be used, for example. Meanwhile, apart from including the processor 7, the semiconductor device 20C can also include, for example, the main memory 8.

When the power amount accumulated in the electric storage unit 5 is decreased to the first power amount P1, the semiconductor device 20C reduces the power consumption of the processor 7. In contrast, when the power amount accumulated in the electric storage unit 5 is increased to the second power amount P2 that is larger than the first power amount P1, the semiconductor device 20B increases the power consumption of the processor 7. Herein, reducing the power consumption of the processor 7 corresponds to the state in which the processor 7 is caused to transit from the activated state to the suspended state. For example, by deactivating the processor 7 that is executing a program, the power consumption of the processor 7 is reduced. Furthermore, increasing the power consumption of the processor 7 corresponds to the state in which the processor 7 is caused to transit from the suspended state to the activated state. For example, by reactivating the processor 7 to resume the execution of the program, the power consumption of the processor 7 is increased.

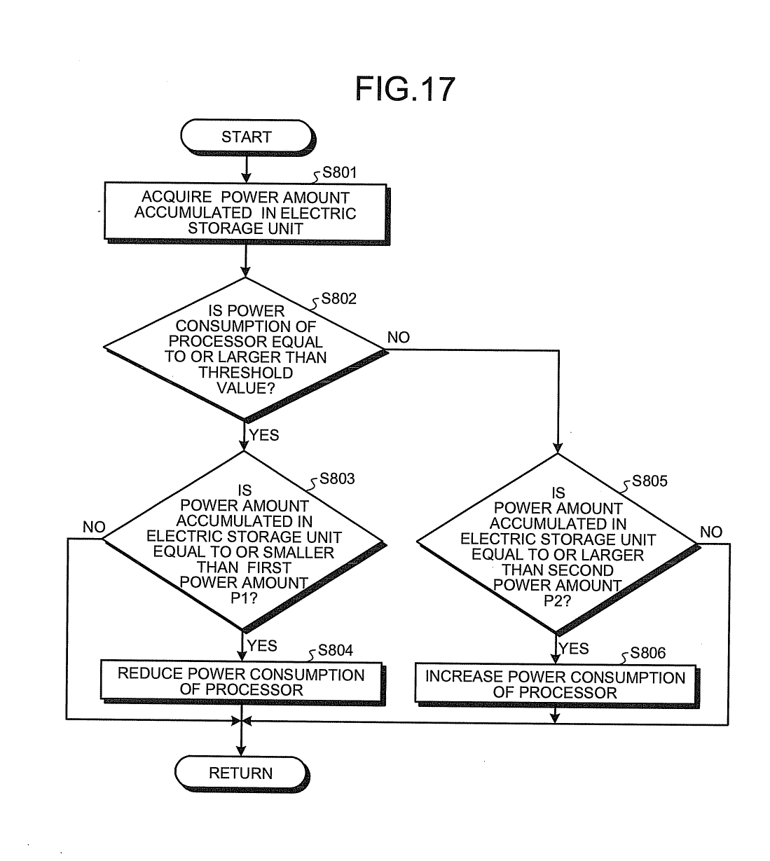

FIG. 17 is a flowchart illustrating processes performed by the semiconductor device 20C. Herein, the semiconductor device 20C repetitively executes the processes illustrated in the flowchart of FIG. 17 in, for example, a short period of units of 100 milliseconds and controls the power consumption of the processor 7.

First, in step S801, the semiconductor device 20C acquires a power amount accumulated in the electric storage unit 5 through the detection unit 11. Then, the semiconductor device 20C determines whether the power consumption of the processor 7 is equal to or larger than a predetermined threshold value in step S802. If the power consumption of the processor 7 is equal to or larger than the predetermined threshold value (Yes in step S802), then the semiconductor device 20C determines whether or not the power amount acquired in step S801, that is, the power amount accumulated in the electric storage unit 5 is equal to or smaller than the first power amount P1 in step S803. If the power amount accumulated in the electric storage unit 5 is equal to or smaller than the first power amount P1 (Yes in step S803), then the semiconductor device 20C reduces the power consumption of the processor 7 in step S804 and returns to step S801. On the other hand, if the power amount accumulated in the electric storage unit 5 has exceeded the first power amount P1 (No in step S803), then the semiconductor device 20C returns to step S801 without reducing the power consumption of the processor 7.

Meanwhile, if the power consumption of the processor 7 is smaller than the predetermined threshold value (No in step S802), then the semiconductor device 20C determines whether or not the power amount acquired in step S801, that is, the power amount accumulated in the electric storage unit 5 is equal to or larger than the second power amount P2 in step S805. If the power amount accumulated in the electric storage unit 5 is equal to or larger than the second power amount P2 (Yes in step S805), then the semiconductor device 20C increases the power consumption of the processor 7 in step S806 and returns to step S801. On the other hand, if the power amount accumulated in the electric storage unit 5 is smaller than the second power amount P2 (No in step S805), then the semiconductor device 20C returns to step S801 without increasing the power consumption of the processor 7.

As described above, in the information processing device 1C according to the third modification example, the semiconductor device 20C that includes the processor 7 controls the power consumption of the processor 7 according to the power amount accumulated in the electric storage unit 5. As a result, the appropriate state transition according to usage environment can be achieved without the user's awareness.

### Fourth Modification Example

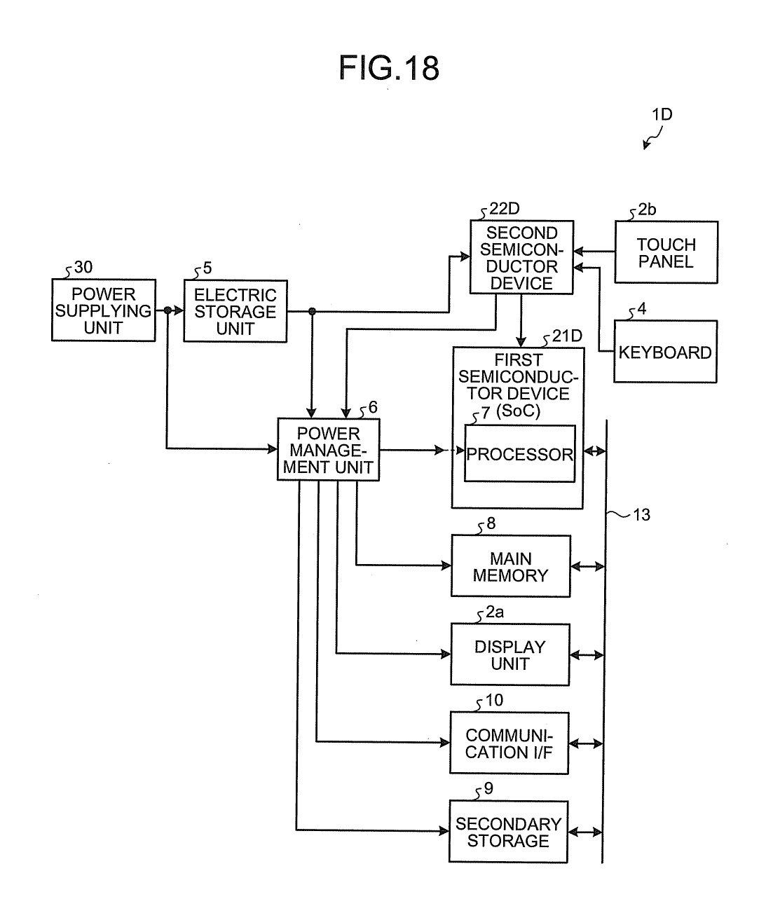

FIG. 18 is a block diagram illustrating a hardware configuration example of an information processing device 1D according to a fourth modification example. In the information processing device 1D according to the fourth modification example, the constituent elements identical to those in the information processing device 1 are referred to by the same reference numerals. As illustrated in FIG. 18, the information processing device 1D according to the fourth modification example includes a first semiconductor device 21D that is configured as an SoC which includes the processor 7; as well as includes a second semiconductor device 22D that controls the processor 7. Herein, the processor 7 or the first semiconductor device 21D receives the supply of power that is accumulated in the electric storage unit 5. The electric storage unit 5 accumulates power that is supplied by a power supplying unit 30. As the power supply unit, the abovementioned solar cell 3 may be used, for example. Meanwhile, apart from including the processor 7, the first semiconductor device 21D can also include, for example, the main memory 8.

When the power amount accumulated in the electric storage unit 5 is decreased to the first power amount P1 while the processor 7 is running, the second semiconductor device 22D deactivates the processor 7. After deactivating the processor 7, when the power amount accumulated in the electric storage unit 5 is increased to the second power amount P2 that is larger than the first power amount P1, the second semiconductor device 22D reactivates the processor 7.

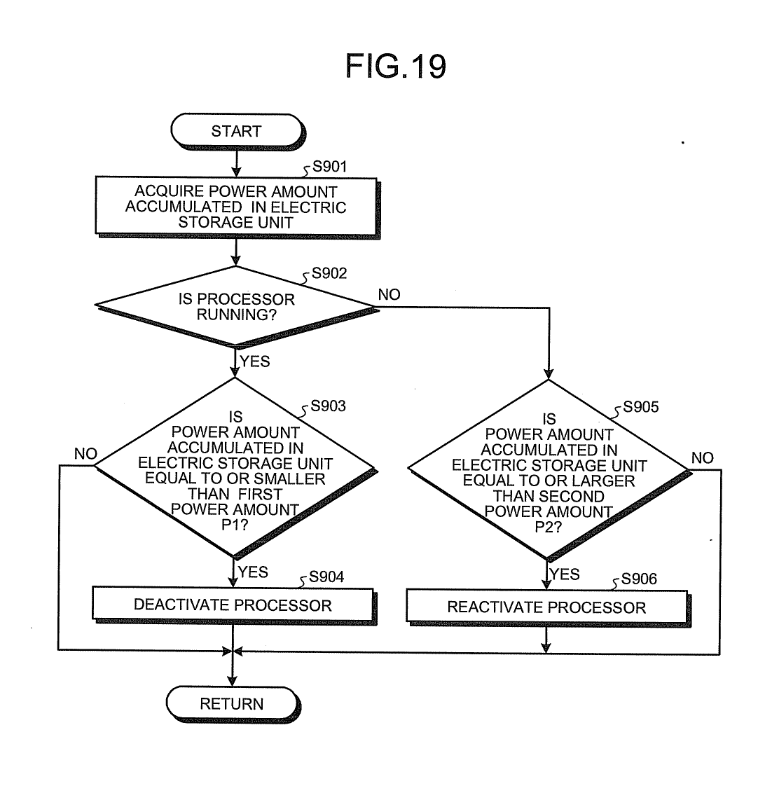

FIG. 19 is a flowchart illustrating processes performed by the second semiconductor device 22D. Herein, the second semiconductor device 22D repetitively executes the processes illustrated in the flowchart of FIG. 19 in, for example, a short period of units of 100 milliseconds and controls deactivation and reactivation of the processor 7.

First, in step S901, the second semiconductor device 22D acquires a power amount accumulated in the electric storage unit 5 through the detection unit 11. Then, the second semiconductor device 22D determines whether or not the processor 7 is running in step S902. If the processor 7 is running (Yes in step S902), then the second semiconductor device 22D determines whether or not the power amount acquired in step S901, that is, the power amount accumulated in the electric storage unit 5 is equal to or smaller than the first power amount P1 in step S903. If the power amount accumulated in the electric storage unit 5 is equal to or smaller than the first power amount P1 (Yes in step S903), then the second semiconductor device 22D deactivates the processor 7 in step S904 and returns to step S901. On the other hand, if the power amount accumulated in the electric storage unit 5 has exceeded the first power amount P1 (No in step S903), then the second semiconductor device 22D returns to step S901 while keeping the processor 7 running.

Meanwhile, if the processor 7 is not running (No in step S902), then the second semiconductor device 22D determines whether or not the power amount acquired in step S901, that is, the power amount accumulated in the electric storage unit 5 is equal to or larger than the second power amount P2 in step S905. If the power amount accumulated in the electric storage unit 5 is equal to or larger than the second power amount P2 (Yes in step S905), then the second semiconductor device 22D reactivates the processor 7 in step S906 and returns to step S901. On the other hand, if the power amount accumulated in the electric storage unit 5 is smaller than the second power amount P2 (No in step S905), then the second semiconductor device 22D returns to step S901 while keeping the processor 7 deactivated.

As described above, in the information processing device 1D according to the fourth modification example, the second semiconductor device 22D controls the deactivation and reactivation of the processor 7 according to the power amount accumulated in the electric storage unit 5. As a result, the appropriate state transition according to usage environment can be achieved without the user's awareness.

### Fifth Modification Example

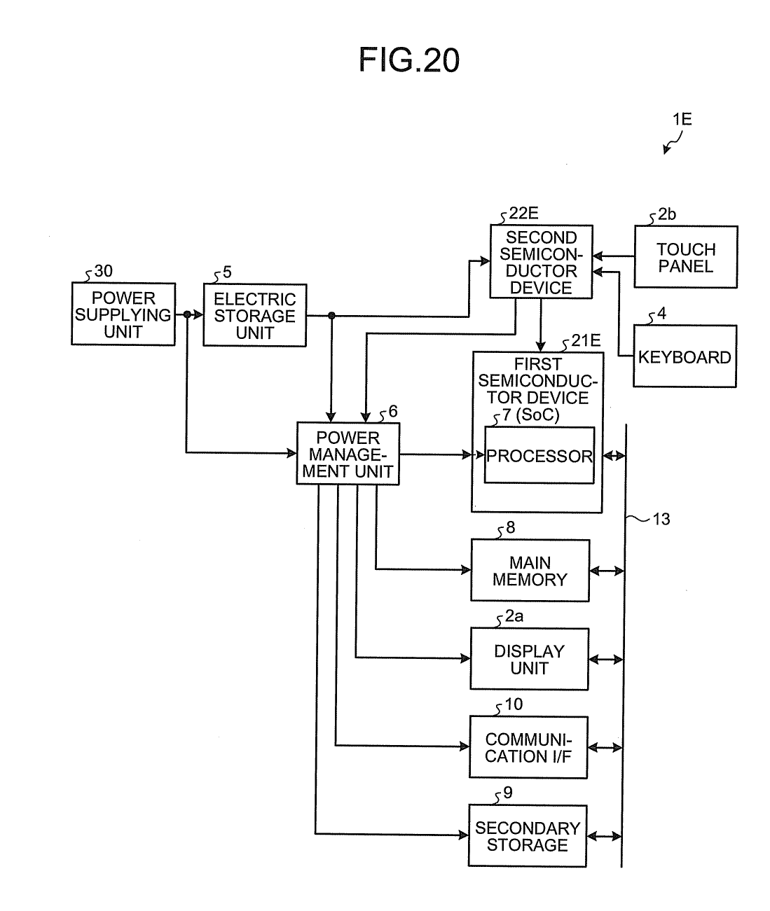

FIG. 20 is a block diagram illustrating a hardware configuration example of an information processing device 1E according to a fifth modification example. In the information processing device 1E according to the fifth modification example, the constituent elements identical to those in the information processing device 1 are referred to by the same reference numerals. As illustrated in FIG. 20, the information processing device 1E according to the fifth modification example includes a first semiconductor device 21E that is configured as an SoC which includes the processor 7; as well as includes a second semiconductor device 22E that is connected to the first semiconductor device 21E. Herein, the first semiconductor device 21E receives the supply of power that is accumulated in the electric storage unit 5. The electric storage unit 5 accumulates power that is supplied by a power supplying unit 30. As the power supply unit, the abovementioned solar cell 3 may be used, for example. Meanwhile, apart from including the processor 7, the first semiconductor device 21E can also include, for example, the main memory 8.

When the power amount accumulated in the electric storage unit 5 is decreased to the first power amount P1, the second semiconductor device 22E reduces the power consumption of the first semiconductor device 21E. In contrast, when the power amount accumulated in the electric storage unit 5 is increased to the second power amount P2 that is larger than the first power amount P1, the second semiconductor device 22E increases the power consumption of the first semiconductor device 21E. Herein, reducing the power consumption of the semiconductor device 20E corresponds to the state in which the processor 7 is caused to transit from the activated state to the suspended state. For example, by deactivating the processor 7 that is executing a program, the power consumption of the semiconductor device 20E is reduced. Furthermore, increasing the power consumption of the semiconductor device 20E corresponds to the state in which the processor 7 is caused to transit from the suspended state to the activated state. For example, by reactivating the processor 7 to resume the execution of the program, the power consumption of the semiconductor device 20E is increased.

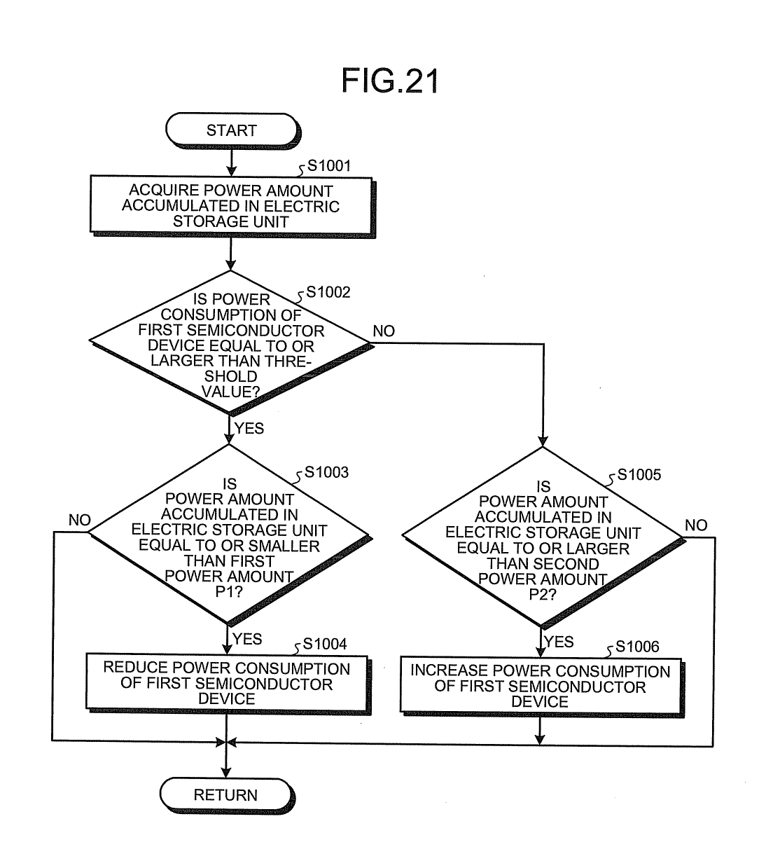

FIG. 21 is a flowchart illustrating processes performed by the second semiconductor device 22E. Herein, the second semiconductor device 22E repetitively executes the processes illustrated in the flowchart of FIG. 21 in, for example, a short period of units of 100 milliseconds and controls the power consumption of the first semiconductor device 21E.

First, in step S1001, the second semiconductor device 22E acquires a power amount accumulated in the electric storage unit 5 through the detection unit 11. Then, the second semiconductor device 22E determines whether the power consumption of the first semiconductor device 21E is equal to or larger than a predetermined threshold value in step S1002. If the power consumption of the first semiconductor device 21E is equal to or larger than the predetermined threshold value (Yes in step S1002), then the second semiconductor device 22E determines whether or not the power amount acquired in step S1001, that is, the power amount accumulated in the electric storage unit 5 is equal to or smaller than the first power amount P1 in step S1003. If the power amount accumulated in the electric storage unit 5 is equal to or smaller than the first power amount P1 (Yes in step S1003), then the second semiconductor device 22E reduces the power consumption of the first semiconductor device 21E in step S1004 and returns to step S1001. On the other hand, if the power amount accumulated in the electric storage unit 5 has exceeded the first power amount P1 (No in step S1003), then the second semiconductor device 22E returns to step S1001 without reducing the power consumption of the first semiconductor device 21E.

Meanwhile, if the power consumption of the first semiconductor device 21E is smaller than the predetermined threshold value (No in step S1002), then the second semiconductor device 22E determines whether or not the power amount acquired in step S1001, that is, the power amount accumulated in the electric storage unit 5 is equal to or larger than the second power amount P2 in step S1005. If the power amount accumulated in the electric storage unit 5 is equal to or larger than the second power amount P2 (Yes in step S1005), then the second semiconductor device 22E increases the power consumption of the first semiconductor device 21E in step S1006 and returns to step S1001. On the other hand, if the power amount accumulated in the electric storage unit 5 is smaller than the second power amount P2 (No in step S1005), then the second semiconductor device 22E returns to step S1001 without increasing the power consumption of the first semiconductor device 21E.

As described above, in the information processing device 1E according to the fifth modification example, the second semiconductor device 22E, which is connected to the first semiconductor device 21E that includes the processor 7, controls the power consumption of the first semiconductor device 21E according to the power amount accumulated in the electric storage unit 5. As a result, the appropriate state transition according to usage environment can be achieved without the user's awareness.

Meanwhile, although the first modification example to the fifth modification example are described as modification examples of the first embodiment, it is also possible to implement those modification examples to any one of the first to fifth embodiments described above.

While certain embodiments and modification examples thereof have been described, these embodiments and the modification examples thereof have been presented by way of example only, and are not intended to limit the scope of the inventions. Indeed, the novel embodiments and the modification examples thereof described herein may be embodied in a variety of other forms; furthermore, various omissions, substitutions and changes in the form of the embodiments and the modification examples thereof described herein may be made without departing from the spirit of the inventions. The accompanying claims and their equivalents are intended to cover such forms or modifications as would fall within the scope and spirit of the inventions.

What is claimed is:

1. A state control device for controlling a state transition of an information processing device that includes:
a processor;
a power supply unit configured to supply power to at least the processor; and
an electric storage unit configured to accumulate surplus power of the power supply unit, and supply the accumulated power to at least the processor when power supplied by the power supply unit is insufficient,
the state control device comprising:
a controller configured to, when the power amount accumulated in the electric storage unit is decreased to a first power amount while the information processing device is in a first state, cause the information processing device to transit from the first state to a second state in which power consumption of the processor is lower than that in the first state, and configured to, when the power amount accumulated in the electric storage unit is increased to a second power amount larger than the first power amount while the information processing device is in the second state, cause the information processing device to transit from the second state to the first state.

2. An information processing device comprising:
a processor;
a power supply unit configured to supply power to at least the processor;
an electric storage unit configured to accumulate surplus power of the power supply unit, and supply the accumulated power to at least the processor when power supplied by the power supply unit is insufficient; and
a state controller configured to cause the information processing device to transit from a first state to a second state in which power consumption of the processor is lower than that in the first state when the power amount accumulated in the electric storage unit is decreased to a first power amount while the information processing device is in a first state, and configured to cause the information processing device to transit from the second state to the first state when the power amount accumulated in the electric storage unit is increased to a second power amount larger than the first power amount while the information processing device is in the second state.

3. The device according to claim 2,
wherein the first power amount is a power amount exceeding at least a power amount necessary for causing the information processing device to transit from the first state to the second state, and
the second power amount is a power amount exceeding at least the sum of a power amount necessary for causing the information processing device to transit from the second state to the first state and the power amount necessary for causing the information processing device to transit from the first state to the second state.

4. The device according to claim 2, further comprising a main memory,
wherein the state controller writes, into the main memory, data necessary for recovering an operating state of the processor when the information processing device is caused to transit from the first state to the second state, and recovers the operating state of the processor by reading the data from the main memory when the information processing device is caused to transit from the second state to the first state.

5. The device according to claim 2, further comprising:
a main memory; and
an input/output device configured to perform data input and output,
wherein the state controller writes, into the main memory, data necessary for recovering an operating state of the input/output device when the information processing device is caused to transit from the first state to the second state, and recovers the operating state of the input/output device by reading the data from the main memory when the information processing device is caused to transit from the second state to the first state.

6. The device according to claim 4,
wherein the main memory is a volatile memory,
the first power amount is a power amount exceeding at least the sum of a power amount necessary for causing the information processing device to transit from the first state to the second state and a power amount necessary for supplying power to the main memory for a predetermined period of time, and
the second power amount is a power amount exceeding at least the sum of a power amount necessary for causing the information processing device to transit from the second state to the first state, the power amount necessary for causing the information processing device to transit from the first state to the second state, and a power amount necessary for supplying the power to the main memory for a predetermined period of time.

7. The device according to claim 5,
wherein the main memory is a volatile memory,
the first power amount is a power amount exceeding at least the sum of a power amount necessary for causing the information processing device to transit from the first state to the second state and a power amount necessary for supplying power to the main memory for a predetermined period of time, and
the second power amount is a power amount exceeding at least the sum of a power amount necessary for causing the information processing device to transit from the second state to the first state, the power amount necessary for causing the information processing device to transit from the first state to the second state, and a power amount necessary for supplying the power to the main memory for a predetermined period of time.

8. The device according to claim 6, further comprising a nonvolatile secondary storage,
wherein when the power amount accumulated in the electric storage unit is decreased to a third power amount smaller than the first power amount while the information processing device is in the second state, the state controller saves data of the main memory into the secondary storage.

9. The device according to claim 7, further comprising a nonvolatile secondary storage,
wherein when the power amount accumulated in the electric storage unit is decreased to a third power amount smaller than the first power amount while the information processing device is in the second state, the state controller saves data of the main memory into the secondary storage.

10. The device according to claim 4,
wherein the main memory is a nonvolatile memory.

11. The device according to claim 5,
wherein the main memory is a nonvolatile memory.

12. The device according to claim 2, further comprising an input/output device configured to perform data input and output,
wherein, when starting input and output operations of the input/output device, the processor causes the input and output operations of the input/output device to start when a power amount sufficient to complete the input and output operations of the input/output device is accumulated in the electric storage unit, and the processor causes the input and output operations of the input/output device to stand by when a sufficient power amount is not accumulated in the electric storage unit.

13. The device according to claim 2, further comprising an input device that is used to input data,
wherein the state controller causes the information processing device to transit from the second state to the first state when the power amount accumulated in the electric storage unit is increased to the second power amount while the information processing device is in the second state and the generation of input data from the input device is detected.

14. A computer program product comprising a computer-readable medium containing a program that causes an information processing device that includes a processor, a power supply unit configured to supply power to at least the processor, an electric storage unit configured to accumulate surplus power of the power supply unit and supply the accumulated power to at least the processor when the power supplied by the power supply unit is insufficient, to execute:
causing the information processing device to transit from a first state to a second state in which power consumption of the processor is lower than that in the first state, when the power amount accumulated in the electric storage unit is decreased to a first power amount while the information processing device is in a first state; and
causing the information processing device to transit from the second state to the first state, when the power amount accumulated in the electric storage unit is increased to a second power amount larger than the first power amount while the information processing device is in the second state.

15. A semiconductor device comprising a processor, wherein
the processor receives supply of power that is accumulated in an electric storage unit,
the electric storage unit accumulates power that is supplied by a power supplying unit,
when a power amount accumulated in the electric storage unit is decreased to a first power amount, the semiconductor device reduces power consumption thereof, and
when the power amount accumulated in the electric storage unit is increased to a second power amount that is larger than the first power amount, the semiconductor device increases power consumption thereof.

16. A semiconductor device that performs information processing, wherein
the semiconductor device receives supply of power that is accumulated in an electric storage unit,
the electric storage unit accumulates power that is supplied by a power supplying unit,
when a power amount accumulated in the electric storage unit is decreased to a first power amount, the semiconductor device reduces power consumption thereof, and
when the power amount accumulated in the electric storage unit is increased to a second power amount that is larger than the first power amount, the semiconductor device increases power consumption thereof.

17. A semiconductor device that is connected to an SoC which includes a processor, wherein
the SoC receives supply of power that is accumulated in an electric storage unit,
the electric storage unit accumulates power that is supplied by a power supplying unit,
when a power amount accumulated in the electric storage unit is decreased to a first power amount, the semiconductor device reduces power consumption of the SoC, and
when the power amount accumulated in the electric storage unit is increased to a second power amount that is larger than the first power amount, the semiconductor device increases power consumption of the SoC.
